(19) United States
(12) Patent Application Publication
(10) Pub. No.: US 2026/0288443 A1
(43) Pub. Date: Sep. 24, 2026

(54) UPDATE MANAGEMENT DEVICE, UPDATE MANAGEMENT SYSTEM, AND COMPUTER PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Makoto MOTOYAMA, Yokkaichi-shi, Mie (JP); Shota USHIRO, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/131,093

(22) PCT Filed: Nov. 1, 2023
(86) PCT No.: PCT/JP2023/039479

§ 371 Date: May 19, 2025

(30) Foreign Application Priority Data
Nov. 21, 2022 (JP) 2022-185655

(51) Int. Cl. G06F 8/65

(52) U.S. Cl. CPC G06F 8/65

(57) ABSTRACT

An update management device includes: a reception unit that receives, from an external device outside the vehicle, first update data for updating first software and second update data for updating second software; a compositing unit that creates, from the first update data and the second update data, composite update data for installing composite software including a first function that is a function of the updated first software and a second function that is a function of the updated second software; and a transmission unit that transmits the composite update data to the in-vehicle device so that the in-vehicle device installs the composite software in a recording unit, activates the first function when in the first power source state, and activates the second function when in the second power source state.

### CROSS-REFERENCE TO RELATED APPLICATIONS

This application is the U.S. national stage of PCT/JP2023/039479 filed on Nov. 1, 2023, which claims priority of Japanese Patent Application No. JP 2022-185655 filed on Nov. 21, 2022, the contents of which are incorporated herein.

### TECHNICAL FIELD

The present disclosure relates to an update management device, an update management system, and a computer program.

### BACKGROUND

An in-vehicle device is known which is mounted in a vehicle and to which a plurality of electronic control units (ECUs) are connected. In recent years, power sources of vehicles have become more complex and their power source states have become more diverse. In addition, accompanying the diversification of vehicle controls, such as parking assistance systems, opportunities to update software installed in ECUs are also increasing in number.

JP 2020-27629A discloses a vehicle master device that acquires update data from an external device, instructs an ECU that is to be rewritten to perform installation using the acquired update data, and distributes the acquired update data to the ECU that is to be rewritten, the vehicle master device including: an installation condition determination unit that determines whether or not all of the following conditions are satisfied: a first condition that a user's approval for installation has been obtained, a second condition that data communication with a center device is possible, a third condition that a vehicle state is a state where installation is possible, a fourth condition that the ECU that is to be rewritten is in a state where installation is possible, and a fifth condition that the update data is normal data; and an installation instruction unit that instructs an electronic control device that is to be rewritten to perform installation using the update data if it is determined by the installation condition determination unit that all of the first condition, the second condition, the third condition, the fourth condition, and the fifth condition are satisfied.

A vehicle is known which has a plurality of power source states including a +B state, which is a power source state at a time when the vehicle is in a state of not being able to travel, and an IG state, which is a power source state at a time when the vehicle is in a state of being able to travel, a plurality of ECUs being mounted in the vehicle. For example, first software that operates in the +B state and the IG state and second software that does not operate in the +B state but operates in the IG state are installed in a first ECU, third software that does not operate in the +B state but operates in the IG state is installed in a second ECU, and a predetermined system may operate due to cooperation between the second software and third software.

If the first software and the second software of the first ECU are updated according to update data, the first software and the second software can be activated even in the +B state because they are installed in one first ECU. On the other hand, since the third software that operates in the IG state is installed in the second ECU, when the power source state transitions to the IG state, installation of the third software starts according to the update data and the third software is activated. If the second software of the first ECU has already been activated in the +B state, the second software issues a command to the third software of the second ECU when the power source state transitions to the IG state in some cases. However, the installation of the third software of the second ECU has just started and the third software may not understand the command issued by the second software of the first ECU, which may result in the predetermined system not functioning,

The vehicle master device of JP 2020-27629A is compatible with one ECU, but cannot accommodate a case in which a predetermined system operates due to cooperation between a plurality of ECUs in a vehicle having a plurality of power source states.

### SUMMARY

An update management device according to the present disclosure is an update management device for managing update of software of an in-vehicle device in a vehicle having a plurality of power source states including a first power source state and a second power source state different from the first power source state, the update management device including: a reception unit configured to receive, from an external device outside the vehicle, first update data for updating first software that operates in the first power source state and the second power source state, and second update data for updating second software that does not operate in the first power source state but operates in the second power source state; a determination unit configured to determine whether the power source state of the vehicle is the first power source state or the second power source state; a first transmission unit configured to, when the determination unit determines that the power source state of the vehicle is the first power source state, transmit the first update data to the in-vehicle device including a first storage unit and a second storage unit, so that the in-vehicle device installs the updated first software in the first storage unit and activates the updated first software; and a second transmission unit configured to, when the determination unit determines that the power source state of the vehicle is the second power source state, transmit the first update data and the second update data to the in-vehicle device, so that the in-vehicle device installs the updated first software and the updated second software in the second storage unit and activates the updated first software and the updated second software.

An update management system according to the present disclosure is an update management system including: an update management device configured to manage update of software of an in-vehicle device in a vehicle having a plurality of power source states including a first power source state and a second power source state different from the first power source state; and the in-vehicle device, in which the update management device includes: a reception unit configured to receive, from an external device outside the vehicle, first update data for updating first software that operates in the first power source state and the second power source state, and second update data for updating second software that does not operate in the first power source state but operates in the second power source state; a determination unit configured to determine whether the power source state of the vehicle is the first power source state or the second power source state; a first transmission unit configured to, when the determination unit determines that the power source state of the vehicle is the first power source state, transmit the first update data to the in-vehicle device including a first storage unit and a second storage unit, so that the in-vehicle device installs the updated first software in the first storage unit and activates the updated first software; a second transmission unit configured to, when the determination unit determines that the power source state of the vehicle is the second power source state, transmit the first update data and the second update data to the in-vehicle device so that the in vehicle device installs the updated first software and the updated second software in the second storage unit and activates the updated first software and the updated second software; a first instruction unit configured to, when the determination unit determines that the power source state of the vehicle is the first power source state, transmit a first activation instruction for activating the updated first software installed in the first storage unit to the in-vehicle device; and a second instruction unit configured to, when the determination unit determines that the power source state of the vehicle is the second power source state, transmit a second activation instruction for activating the updated first software and the updated second software installed in the second storage unit to the in-vehicle device, and the in-vehicle device includes: a first activation unit configured to activate the updated first software installed in the first storage unit, when the first activation instruction is received; and a second activation unit configured to activate the updated first software and the updated second software installed in the second storage unit, when the second activation instruction is received.

A computer program according to the present disclosure is a computer program for controlling an update management device that manages update of software of an in-vehicle device in a vehicle having a plurality of power source states including a first power source state and a second power source state different from the first power source state, the computer program including: a reception step of receiving, from an external device outside the vehicle, first update data for updating first software that operates in the first power source state and the second power source state, and second update data for updating second software that does not operate in the first power source state but operates in the second power source state; a determination step of determining whether the power source state of the vehicle is the first power source state or the second power source state; a first transmission step of, when it is determined that the power source state of the vehicle is the first power source state, transmitting the first update data to the in-vehicle device including a first storage unit and a second storage unit, so that the in-vehicle device installs the updated first software in the first storage unit and activates the updated first software; and a second transmission step of, when it is determined that the power source state of the vehicle is the second power source state, transmitting the first update data and the second update data to the in vehicle device so that the in-vehicle device installs the updated first software and the updated second software in the second storage unit and activates the updated first software and the updated second software.

An update management device according to the present disclosure is an update management device for managing update of software of an in-vehicle device in a vehicle having a plurality of power source states including a first power source state and a second power source state different from the first power source state, the update management device including: a reception unit configured to receive, from an external device outside the vehicle, first update data for updating first software that operates in the first power source state and the second power source state, and second update data for updating second software that does not operate in the first power source state but operates in the second power source state; a compositing unit configured to create, from the first update data and the second update data, composite update data for installing composite software including a first function that is a function of the updated first software and a second function that is a function of the updated second software; and a transmission unit configured to transmit the composite update data to the in vehicle device including a storage unit, so that the in-vehicle device installs the composite software in the storage unit, activates the first function when the power source state of the vehicle is the first power source state, and activates the second function when the power source state of the vehicle is the second power source state,

An update management system according to the present disclosure is an update management system including: an update management device configured to manage update of software of an in-vehicle device in a vehicle having a plurality of power source states including a first power source state and a second power source state different from the first power source state; and the in-vehicle device, in which the update management device includes: a reception unit configured to receive, from an external device outside the vehicle, first update data for updating first software that operates in the first power source state and the second power source state and second update data for updating second software that does not operate in the first power source state but operates in the second power source state; a compositing unit configured to create, from the first update data and the second update data, composite update data for installing composite software including a first function that is a function of the updated first software and a second function that is a function of the updated second software; a transmission unit configured to transmit the composite update data to the in-vehicle device including a storage unit, so that the in-vehicle device installs the composite software in the storage unit, activates the first function when the power source state of the vehicle is the first power source state, and activates the second function when the power source state of the vehicle is the second power source state; a determination unit configured to determine whether the power source state of the vehicle is the first power source state or the second power source state; a first instruction unit configured to, when the determination unit determines that the power source state of the vehicle is the first power source state, transmit a first activation instruction for activating the first function to the in-vehicle device; and a second instruction unit configured to, when the determination unit determines that the power source state of the vehicle is the second power source state, transmit a second activation instruction for activating the second function to the in vehicle device, and the in vehicle device includes: a first activation unit configured to activate the first function when the first activation instruction is received; and a second activation unit configured to activate the second function when the second activation instruction is received.

A computer program according to the present disclosure is a computer program for controlling an update management device that manages update of software of an in-vehicle device in a vehicle having a plurality of power source states including a first power source state and a second power source state different from the first power source state, the computer program including; a reception step of receiving, from an external device outside the vehicle, first update data for updating first software that operates in the first power source state and the second power source state, and second update data for updating second software that does not operate in the first power source state but operates in the second power source state; a compositing step of creating, from the first update data and the second update data, composite update data for installing composite software including a first function that is a function of the updated first software and a second function that is a function of the updated second software; and a transmission step of transmitting the composite update data to the in-vehicle device including a storage unit, so that the in-vehicle device installs the composite software in the storage unit, activates the first function when the power source state of the vehicle is the first power source state, and activates the second function when the power source state of the vehicle is the second power source state.

### Advantageous Effects

The present disclosure can provide an update management device that installs and activates software in each ECU using update data, allowing a predetermined system to operate without any inconsistencies, even when a function operates due to cooperation between a plurality of ECUs in a vehicle having a plurality of power source states.

### BRIEF DESCRIPTION OF DRAWINGS

FIG. 1 is a block diagram showing an example of an update management system.

FIG. 2 is a block diagram showing an example of an internal configuration of an update management ECU,

FIG. 3 is a block diagram showing an example of an internal configuration of an ECU.

FIG. 4 is a functional block diagram of an update management ECU according to a first embodiment.

FIG. 5 is a table showing an example of an ECU table that lists ECUs.

FIG. 6 is a diagram showing an example of an ECU table that lists ECUs.

FIG. 7 is a flowchart showing a control method according to the first embodiment.

FIG. 8 is a sequence diagram of an update management system according to the first embodiment.

FIG. 9 is a functional block diagram of an update management ECU according to a second embodiment.

FIG. 10 is a flowchart showing a control method according to the second embodiment.

FIG. 11 is a sequence diagram of an update management system according to the second embodiment.

### DETAILED DESCRIPTION OF PREFERRED EMBODIMENTS

The gist of the embodiments of the present disclosure includes the following configurations.

In a first aspect, an update management device according to the present disclosure is an update management device for managing update of software of an in-vehicle device in a vehicle having a plurality of power source states including a first power source state and a second power source state different from the first power source state, the update management device including: a reception unit configured to receive, from an external device outside the vehicle, first update data for updating first software that operates in the first power source state and the second power source state, and second update data for updating second software that does not operate in the first power source state but operates in the second power source state; a determination unit configured to determine whether the power source state of the vehicle is the first power source state or the second power source state; a first transmission unit configured to, when the determination unit determines that the power source state of the vehicle is the first power source state, transmit the first update data to the in-vehicle device including a first storage unit and a second storage unit, so that the in-vehicle device installs the updated first software in the first storage unit and activates the updated first software; and a second transmission unit configured to, when the determination unit determines that the power source state of the vehicle is the second power source state, transmit the first update data and the second update data to the in-vehicle device, so that the in-vehicle device installs the updated first software and the updated second software in the second storage unit and activates the updated first software and the updated second software.

With this configuration, the update management device transmits, to the in-vehicle device, update data for installing and activating software alternatingly in the two storage units of the in-vehicle device, depending on the power source state of the vehicle. As a result, the software of the in-vehicle device is updated and activated sequentially at an appropriate time depending on the power source state, whereby a function that operates due to cooperation between the software of a plurality of ECUs operates without any discrepancies.

In a second aspect, the update management device according to the first aspect may further include: a determination unit configured to determine whether the power source state of the vehicle is the first power source state or the second power source state; a first instruction unit configured to, when the determination unit determines that the power source state of the vehicle is the first power source state, transmit a first activation instruction for activating the first function to the in-vehicle device; and a second instruction unit configured to, when the determination unit determines that the power source state of the vehicle is the second power source state, transmit a second activation instruction for activating the second function to the in-vehicle device.

With this configuration, the update management device installs and activates the software in the in-vehicle device according to the update data, depending on the power source state of the vehicle. As a result, the software of the in-vehicle device is updated and activated sequentially at an appropriate time depending on the power source state, whereby a function that operates due to cooperation between the software of a plurality of ECUs operates without any discrepancies.

In a third aspect, the update management device according to the first aspect may further include: a first erasure instruction unit configured to, when the pre-update first software and the pre-update second software have been installed in the second storage unit and the updated first software has been installed in the first storage unit, transmit a first erasure instruction for erasing the pre update first software and the pre update second software from the second storage unit, to the in-vehicle device; and a second erasure instruction unit configured to, when the updated first software has been installed in the first storage unit and the updated first software and the updated second software have been installed in the second storage unit, transmit a second erasure instruction for erasing the updated first software from the first storage unit, to the in-vehicle device.

With this configuration, the update management device causes the in-vehicle device to install software in one of the storage units and activate the software, and then erase the software in the other storage unit. As a result, the storage unit into which the software is to be subsequently installed or the like becomes empty, and the software can subsequently be installed or the like.

In a fourth aspect, in the update management device according to the first aspect, the first power source state may be a power source state at a time when the vehicle is in a state of not being able to travel, and the second power source state may be a power source state at a time when the vehicle is in a state of being able to travel.

With this configuration, the update management device transmits, to the in-vehicle device, update data for installing and activating software alternatingly in the two storage units of the in-vehicle device depending on the power source state at a time when the vehicle can travel and the power source state at a time when the vehicle cannot travel. As a result, the software of the in-vehicle device is updated and activated sequentially at an appropriate time depending on the power source state, whereby a function that operates due to cooperation between the software of a plurality of ECUs operates without any discrepancies.

In a fifth aspect, in the update management device according to the first aspect, the reception unit may receive the first update data and the second update data from the external device while the power source state is the first power source state.

With this configuration, the update data is downloaded to the update management device in the first power source state, and therefore the software is quickly installed and activated after transition to the second power source state is performed.

In a sixth aspect, an update management system of the present disclosure is an update management system including the update management device according to any one of the first to the fifth aspects and the in-vehicle device.

In a seventh aspect, an update management system according to the present disclosure is an update management system including: an update management device configured to manage update of software of an in-vehicle device in a vehicle having a plurality of power source states including a first power source state and a second power source state different from the first power source state; and the in-vehicle device, in which the update management device includes: a reception unit configured to receive, from an external device outside the vehicle, first update data for updating first software that operates in the first power source state and the second power source state, and second update data for updating second software that does not operate in the first power source state but operates in the second power source state; a determination unit configured to determine whether the power source state of the vehicle is the first power source state or the second power source state; a first transmission unit configured to, when the determination unit determines that the power source state of the vehicle is the first power source state, transmit the first update data to the in-vehicle device including a first storage unit and a second storage unit, so that the in-vehicle device installs the updated first software in the first storage unit and activates the updated first software; a second transmission unit configured to, when the determination unit determines that the power source state of the vehicle is the second power source state, transmit the first update data and the second update data to the in-vehicle device so that the in-vehicle device installs the updated first software and the updated second software in the second storage unit and activates the updated first software and the updated second software; a first instruction unit configured to, when the determination unit determines that the power source state of the vehicle is the first power source state, transmit a first activation instruction for activating the updated first software installed in the first storage unit to the in-vehicle device; and a second instruction unit configured to, when the determination unit determines that the power source state of the vehicle is the second power source state, transmit a second activation instruction for activating the updated first software and the updated second software installed in the second storage unit to the in-vehicle device, and the in-vehicle device includes: a first activation unit configured to activate the updated first software installed in the first storage unit, when the first activation instruction is received; and a second activation unit configured to activate the updated first software and the updated second software installed in the second storage unit, when the second activation instruction is received.

With this configuration, the update management device transmits, to the in-vehicle device, update data for installing and activating software alternatingly in the two storage units of the in-vehicle device. Based on the transmitted update data, the in-vehicle device installs and activates the software depending on the power source state of the vehicle. As a result, the software of the in-vehicle device is updated and activated sequentially at an appropriate time depending on the power source state, whereby a function that operates due to cooperation between the software of a plurality of ECUs operates without any discrepancies.

In an eighth aspect, in the update management device of the seventh aspect, the in-vehicle device may further include: a first erasure unit configured to, when the pre update first software and the pre-update second software have been installed in the second storage unit and the updated first software has been installed in the first storage unit, erase the pre-update first software and the pre update second software from the second storage unit; and a second erasure unit configured to, when the updated first software has been installed in the first storage unit and the updated first software and the updated second software have been installed in the second storage unit, erase the updated first software from the first storage unit.

With this configuration, the update management system causes the in-vehicle device to install software in one of the storage units of the in-vehicle device and activate the software, and then erases the software from the other storage unit. As a result, the storage unit of the in-vehicle device into which the software is to subsequently be installed or the like becomes empty, whereby the software can subsequently be installed or the like.

In a ninth aspect, a computer program according to the present disclosure is a computer program for controlling an update management device that manages update of software of an in-vehicle device in a vehicle having a plurality of power source states including a first power source state and a second power source state different from the first power source state, the computer program including: a reception step of receiving, from an external device outside the vehicle, first update data for updating first software that operates in the first power source state and the second power source state, and second update data for updating second software that does not operate in the first power source state but operates in the second power source state; a determination step of determining whether the power source state of the vehicle is the first power source state or the second power source state; a first transmission step of, when it is determined that the power source state of the vehicle is the first power source state, transmitting the first update data to the in vehicle device including a first storage unit and a second storage unit, so that the in-vehicle device installs the updated first software in the first storage unit and activates the updated first software; and a second transmission step of, when it is determined that the power source state of the vehicle is the second power source state, transmitting the first update data and the second update data to the in vehicle device so that the in-vehicle device installs the updated first software and the updated second software in the second storage unit and activates the updated first software and the updated second software.

With this configuration, the update management device transmits, to the in-vehicle device, update data for installing and activating software alternatingly in the two storage units of the in-vehicle device, depending on the power source state of the vehicle. As a result, the software of the in-vehicle device is updated and activated sequentially at an appropriate time depending on the power source state, whereby a function that operates due to cooperation between the software of a plurality of ECUs operates without any discrepancies.

In a tenth aspect, an update management device according to the present disclosure is an update management device for managing update of software of an in-vehicle device in a vehicle having a plurality of power source states including a first power source state and a second power source state different from the first power source state, the update management device including: a reception unit configured to receive, from an external device outside the vehicle, first update data for updating first software that operates in the first power source state and the second power source state, and second update data for updating second software that does not operate in the first power source state but operates in the second power source state; a compositing unit configured to create, from the first update data and the second update data, composite update data for installing composite software including a first function that is a function of the updated first software and a second function that is a function of the updated second software; and a transmission unit configured to transmit the composite update data to the in vehicle device including a storage unit, so that the in-vehicle device installs the composite software in the storage unit, activates the first function when the power source state of the vehicle is the first power source state, and activates the second function when the power source state of the vehicle is the second power source state.

With this configuration, the update management device creates composite update data from two pieces of update data for updating two pieces of software, and transmits, to the in-vehicle device, update data for installing the composite update data in the storage unit of the in-vehicle device and activating the composite update data depending on the power source state of the vehicle. As a result, software of the in-vehicle device is updated and activated sequentially at an appropriate time depending on the power source state, whereby a function that operates due to cooperation between the software of a plurality of ECUs operates without any discrepancies.

In an eleventh aspect, the update management device according to the tenth aspect may further include: a determination unit configured to determine whether the power source state of the vehicle is the first power source state or the second power source state; a first instruction unit configured to, when the determination unit determines that the power source state of the vehicle is the first power source state, transmit a first activation instruction for activating the first function to the in vehicle device; and a second instruction unit configured to, when the determination unit determines that the power source state of the vehicle is the second power source state, transmit a second activation instruction for activating the second function to the in vehicle device.

With this configuration, the update management device causes the in-vehicle device to activate software depending on the power source state of the vehicle. As a result, the software of the in vehicle device is updated and activated sequentially at an appropriate time depending on the power source state, whereby a function that operates due to cooperation between the software of a plurality of ECUs operates without any discrepancies.

In a twelfth aspect in the update management device according to the eleventh aspect, when it is determined that the power source state of the vehicle is the first power source state, the determination unit may store information indicating that the power source state is the first power source state in a state storage unit configured to store information indicating the power source state, when it is determined that the power source state of the vehicle is the second power source state, the determination unit may store information indicating that the power source state is the second power source state in the state storage unit, the first instruction unit may refer to the state storage unit, and transmit the first activation instruction to the in-vehicle device when information indicating the first power source state has been stored, and the second instruction unit may refer to the state storage unit, and transmit the second activation instruction to the in-vehicle device when information indicating the second power source state has been stored.

With this configuration, the update management device causes the in-vehicle device to activate software based on information indicating the power source state of the vehicle. As a result, the software of the in-vehicle device is updated and activated sequentially at an appropriate time depending on the power source state, whereby a function that operates due to cooperation between the software of a plurality of ECUs operates without any discrepancies.

In a thirteenth aspect, in the update management device according to the tenth aspect, the first power source state may be a power source state at a time when the vehicle is in a state of not being able to travel, and the second power source state may be a power source state at a time when the vehicle is in a state of being able to travel.

With this configuration, the update management device creates composite update data from two pieces of update data for updating two pieces of software, and transmits, to the in-vehicle device, update data for installing the composite update data in the storage unit of the in-vehicle device and activating the composite update data depending on the power source state of the in-vehicle device. As a result, software of the in-vehicle device is updated and activated sequentially at an appropriate time depending on the power source state, whereby a function that operates due to cooperation between the software of a plurality of ECUs operates without any discrepancies.

In a fourteenth aspect, in the update management device according to the tenth aspect, the reception unit may receive the first update data and the second update data from the external device while the power source state is the first power source state.

With this configuration, the update data is downloaded to the update management device in the first power source state, and therefore the software is quickly installed and activated after transition to the second power source state is performed.

In a fifteenth aspect, the update management system of the present disclosure is an update management system including the update management device according to any one of the tenth to the fourteenth aspects and the in-vehicle device.

In a sixteenth aspect, an update management system of the present disclosure is an update management system including: an update management device configured to manage update of software of an in-vehicle device in a vehicle having a plurality of power source states including a first power source state and a second power source state different from the first power source state; and the in-vehicle device, in which the update management device includes: a reception unit configured to receive, from an external device outside the vehicle, first update data for updating first software that operates in the first power source state and the second power source state and second update data for updating second software that does not operate in the first power source state but operates in the second power source state; a compositing unit configured to create, from the first update data and the second update data, composite update data for installing composite software including a first function that is a function of the updated first software and a second function that is a function of the updated second software; a transmission unit configured to transmit the composite update data to the in-vehicle device including a storage unit, so that the in-vehicle device installs the composite software in the storage unit, activates the first function when the power source state of the vehicle is the first power source state, and activates the second function when the power source state of the vehicle is the second power source state; a determination unit configured to determine whether the power source state of the vehicle is the first power source state or the second power source state; a first instruction unit configured to, when the determination unit determines that the power source state of the vehicle is the first power source state, transmit a first activation instruction for activating the first function to the in-vehicle device; and a second instruction unit configured to, when the determination unit determines that the power source state of the vehicle is the second power source state, transmit a second activation instruction for activating the second function to the in vehicle device, and the in-vehicle device includes: a first activation unit configured to activate the first function when the first activation instruction is received; and a second activation unit configured to activate the second function when the second activation instruction is received.

With this configuration, the update management device creates composite update data from two pieces of update data for updating two pieces of software, and transmits, to the in vehicle device, update data for installing the composite update data in the storage unit of the in-vehicle device and activating the composite update data depending on the power source state of the vehicle. Then, depending on the power source state of the vehicle, the update management device sends an activation instruction to the in-vehicle device, and the in-vehicle device activates the software. As a result, the software of the in-vehicle device is updated and activated sequentially at an appropriate time depending on the power source state, whereby a function that operates due to cooperation between the software of a plurality of ECUs operates without any discrepancies.

In a seventeenth aspect, in the update management system of the sixteenth aspect, when it is determined that the power source state of the vehicle is the first power source state, the determination unit stores information indicating that the power source state is the first power source state in a state storage unit configured to store information indicating the power source state, when it is determined that the power source state of the vehicle is the second power source state, the determination unit stores information indicating that the power source state is the second power source state in the state storage unit, the first instruction unit refers to the state storage unit, and transmits the first activation instruction to the in-vehicle device when information indicating the first power source state has been stored, and the second instruction unit refers to the state storage unit, and transmits the second activation instruction to the in-vehicle device when information indicating the second power source state has been stored.

With this configuration, the update management device causes the in-vehicle device to activate software based on information indicating the power source state of the vehicle. As a result, the software of the in-vehicle device is updated and activated sequentially at an appropriate time depending on the power source state, whereby a function that operates due to cooperation between the software of a plurality of ECUs operates without any discrepancies.

In an eighteenth aspect, a computer program of the present disclosure is a computer program for controlling an update management device that manages update of software of an in-vehicle device in a vehicle having a plurality of power source states including a first power source state and a second power source state different from the first power source state, the computer program including: a reception step of receiving, from an external device outside the vehicle, first update data for updating first software that operates in the first power source state and the second power source state, and second update data for updating second software that does not operate in the first power source state but operates in the second power source state; a compositing step of creating, from the first update data and the second update data, composite update data for installing composite software including a first function that is a function of the updated first software and a second function that is a function of the updated second software; and a transmission step of transmitting the composite update data to the in-vehicle device including a storage unit, so that the in vehicle device installs the composite software in the storage unit, activates the first function when the power source state of the vehicle is the first power source state, and activates the second function when the power source state of the vehicle is the second power source state.

With this configuration, the update management device creates composite update data from two pieces of update data for updating two pieces of software, and transmits, to the in-vehicle device, update data for installing the composite update data in the storage unit of the in-vehicle device and activating the composite update data depending on the power source state of the vehicle. As a result, the software of the in vehicle device is updated and activated sequentially at an appropriate time depending on the power source state, whereby a function that operates due to cooperation between the software of a plurality of ECUs operates without any discrepancies.

### First Embodiment

### Details of First Embodiment of the Present Disclosure

Hereinafter, the details of a first embodiment of the present disclosure will be described with reference to the drawings.

### Configuration of Update Management System

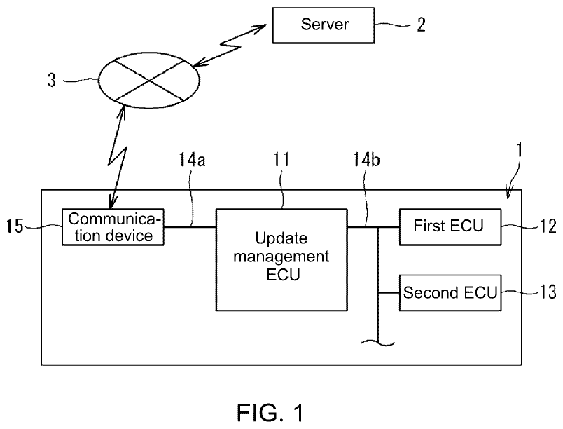

FIG. 1 is a diagram showing an example of a configuration of an update management system 1 according to a first embodiment.

The update management system 1 is a system mounted in a vehicle such as an automobile. The update management system 1 includes an update management ECU 11, a first ECU 12, a second ECU 13, communication buses 14a and 14b, and a communication device 15.

The update management ECU 11 (Electronic Control Unit) is an update management device that manages software updates of an in-vehicle device in a vehicle having a plurality of power source states including a first power source state and a second power source state different from the first power source state. The first power source state is, for example, a power source state at a time when the vehicle is in a state of not being able to travel, and the second power source state is a power source state at a time when the vehicle is in a state of being able to travel.

The first power source state is, for example, a power source state at a time when a key switch into which a key is inserted to start the engine is in an OFF position. Specifically, for example, the first power source state is a state in which power is not supplied from the battery of the vehicle to most of the electrical devices in the vehicle, but power is directly supplied only to the minimum necessary in-vehicle devices. A small number of electrical devices include, for example, a security system, a clock, and the like. Hereinafter, the first power source state is referred to as the +B state in some cases.

The second power source state is, for example, a power source state at a time when a key switch for starting the engine is in an ignition position. Specifically, for example, the second power source state is a state in which power is supplied to all electrical devices and the vehicle starts traveling when an accelerator is depressed. Hereinafter, the second power source state is referred to as the IG state in some cases.

Note that although the following description will be given assuming that the vehicle has two power source states, namely a first power source state and a second power source state, there is no limitation to this, and the power source states may also be further subdivided. Also, the in-vehicle device is referred to as an ECU in some cases.

The update management ECU 11 manages update of software of the in-vehicle device in a vehicle with a plurality of power source states. To do so, the update management ECU 11 is configured to operate in a power source state in which update of software is performed. For example, the update management ECU 11 is capable of operating in the +B state and the IG state.

For example, the update management ECU 11 functions as an integrated ECU that manages the first ECU 12 and the second ECU 13. For example, the update management ECU 11 may transmit update data downloaded from a server 2, which is an external apparatus that is outside the vehicle and is connected via a network 3, to the first ECU 12 and the second ECU 13.

The update management ECU 11 may function as a gateway-ECU (GW-ECU) that relays data transmitted and received between the communication device 15 and the first ECU 12 and second ECU 13. The internal configuration of the update management ECU 11 will be described later.

The communication device 15 is, for example, a communication interface that performs wireless communication. The communication device 15 communicates with the server 2 via a network 3 such as the Internet. Specifically, the communication device 15 is a telematics communication unit (TCU). The communication device 15 transmits the data output from the update management ECU 11 to the server 2 via the network 3. In addition, the communication device 15 receives data (update data, etc.) transmitted from the server 2 via the network 3. The communication device 15 transmits the data to the update management ECU 11 via the communication bus 14a.

The server 2 is a device installed outside the vehicle. The server 2 is, for example, a server including a control unit, a storage unit, and a communication unit (not shown). The storage unit of the server 2 stores, for example, programs or data for controlling each unit of the update management system 1 (e.g., the update management ECU 11, the first ECU 12, and the second ECU 13). For example, the manufacturer of the first ECU 12 and the second ECU 13 updates the programs or data as necessary, and stores the updated programs or data in the storage unit of the server 2 as needed. The control unit of the server 2 uses the communication unit to transmit the updated programs or data to the update management ECU 11 as update data.

The communication buses 14a and 14b are an in-vehicle communication network that is connected to the update management ECU 11. The communication buses 14a and 14b that extend from the update management ECU 11 are connected to various devices (the first ECU 12, the second ECU 13, and the communication device 15, etc.). Although the two communication buses 14a and 14b extend from the update management ECU 11 in the example illustrated in FIG. 1, there is no particular limit on the number of communication buses. For example, the communication buses 14a and 14b are compliant with a communication protocol such as controller area network (CAN), Ethernet (registered trademark), or FlexRay (registered trademark), but there is no limitation to these.

The update management ECU 11 is connected to the first ECU 12 and the second ECU 13 via the communication bus 14b. In the example of FIG. 1, the update management ECU 11 is connected to the first ECU 12 and the second ECU 13 via the communication bus 14b.

The number of ECUs included in the update management system 1 is not particularly limited as long as it is two or more. The ECU is, for example, a device (operation system ECU) that controls each portion of the vehicle (e.g., a braking device, doors, battery, air conditioner, etc.). The plurality of ECUs may have different functions or may have the same function as each other.

The first ECU 12 is an ECU in which first software that operates in the +B state and the IG state and second software that does not operate in the +B state but operates in the IG state are installed. The internal configuration of the first ECU 12 will be described later. Note that in some cases, software that operates in both the +B state and the IG state is sometimes called +B software, and software that does not operate in the +B state but operates in the IG state is called IG software.

The second ECU 13 is an ECU in which IG drive software is installed. The internal configuration of the second ECU 13 will be described later.

### Internal Configuration of Update Management ECU 11

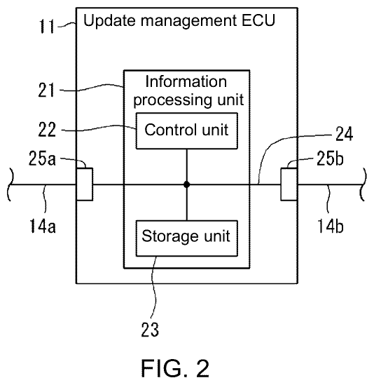

FIG. 2 is a diagram showing one example of an internal configuration of the update management ECU 11.

The update management ECU 11 includes an information processing unit 21 including a control unit 22 and a storage unit 23, and a plurality of transceivers 25a and 25b. These units are electrically connected by an internal bus 24.

Although the control unit 22 includes one or a plurality of central processing units (CPUs), there is no limitation to this. In the case of CPUs, the control unit 22 executes various types of computation and control by reading out a computer program stored in the storage unit 23.

The storage unit 23 includes a volatile memory and a non-volatile memory, and stores various data. The volatile memory includes RAM (Random Access Memory), for example. Examples of non-volatile memory include flash memory, a hard disk drive (HDD), a solid state drive (SSD), and read-only memory (ROM). Part of the non-volatile memory may be provided outside the update management ECU 11.

For example, the storage unit 23 stores computer programs, various parameters, and tables in the non-volatile memory. Note that in one example, the storage unit 23 stores computer programs, various parameters, and tables that are downloaded from the server 2 via the network 3 and the communication device 15.

The plurality of transceivers 25a and 25b transmit and receive signals passing through the communication buses 14a and 14b via respective ports (not shown). The transceivers 25a and 25b send the information included in the received signal to the control unit 22 via the internal bus 24. The transceivers 25a and 25b receive information sent by the control unit 22 via the internal bus 24 and transmit the received information to the communication buses 14a and 14b, The transceiver 25a is connected to the communication bus 14a, and the transceiver 25b is connected to the communication bus 14b.

Note that although an example where the control unit 22 of the information processing unit 21 includes a CPU is described above, the control unit 22 is not limited to this. For example, the information processing unit 21 may be a field programmable gate array (FPGA), an application specific integrated circuit (ASIC), or the like. In the case of an FPGA, the information processing unit 21 executes various types of computation and control according to a configuration that has been programmed in advance. In the case of an ASIC, the information processing unit 21 executes various types of computation and control according to a configuration that is internally configured during manufacturing.

### Internal Configuration of ECU

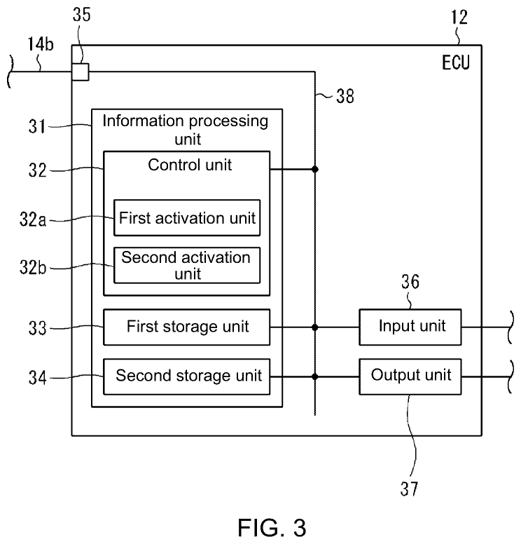

FIG. 3 is a diagram showing an example of an internal configuration of the first ECU 12. The internal configuration of the second ECU 13 is the same as that of the first ECU 12, and will therefore not be described.

The first ECU 12 includes an information processing unit 31, which includes a control unit 32, a first storage unit 33, and a second storage unit 34, a transceiver 35, an input unit 36, and an output unit 37. The transceiver 35 is electrically connected via an internal bus 38 to the information processing unit 31.

The control unit 32 includes, for example, one or more CPUs, but there is no limitation to this. In the case of a CPU, for example, the CPU reads out a computer program stored in the first storage unit 33 or the second storage unit 34 and executes various types of computation and control.

Similarly to the storage unit 23, the first storage unit 33 and the second storage unit 34 each have a volatile memory and a non-volatile memory, and store various types of data. The first storage unit 33 stores, for example, a computer program, various parameters, and tables in a non volatile memory. For example, each of the first storage unit 33 and the second storage unit 34 is one bank obtained by dividing a physical memory into several banks. The information processing unit 31 may further include a bank register (not shown) for switching between banks. For example, the bank register is configured such that writing a 0 to the bank register makes the first storage unit 33 accessible, and writing a 1 to the bank register makes the second storage unit accessible. In another example, the first storage unit and the second storage unit may be the same storage unit, and for example, physical memory may be divided into several address spaces, with the memory in the first address space being the first storage unit 33 and the memory in the second address space being the second storage unit 34.

The transceiver 35 is constituted by, for example, an integrated circuit (IC) and is, for example, a CAN transceiver. The transceiver 35 is connected to the communication bus 14b and receives various control messages from the communication bus 14b.

The transceiver 35 includes a transmission circuit and a reception circuit (not shown). The transmission circuit and the reception circuit communicate in compliance with the communication protocol of the communication bus 14b. The transmission circuit converts the data of the digital signal output by the information processing unit 31 into a predetermined analog signal and sends the result to the communication bus 14b. The reception circuit converts the analog signal input from the communication bus 14b into a digital signal that can be read by the information processing unit 31, and outputs the digital signal to the information processing unit 31.

For example, the input unit 36 is connected to a sensor, an input device, and the like. The input unit 36 receives signals corresponding to the state of the vehicle and signals corresponding to instructions from the driver or the like. For example, the sensors are a temperature sensor that detects the temperature inside the vehicle and door switches that detect whether the doors are closed. For example, the input device is a switch or the like for operating an air conditioner.

For example, the output unit 37 is connected to a motor, a solenoid, or the like. The output unit 37 drives the motor, solenoid, or the like that has been connected based on information sent by the information processing unit 31. For example, this information is information indicating the operation of a motor or the like that has been connected. For example, this motor is a motor that raises and lowers a door window. The solenoid is a solenoid that locks a door, for example.

### Problems to be Solved by the Present Embodiment

A vehicle is known which has a plurality of power source states including a +B state, an IG state, and the like, and in which a plurality of ECUs are mounted. For example, first software that operates in the +B state and the IG state and second software that does not operate in the +B state but operates in the IG state are installed in a first ECU, and third software that does not operate in the +B state but operates in the IG state is installed in a second ECU. In such a situation, a predetermined system operates due to cooperation between the second software and the third software in some cases.

If the first software and the second software of the first ECU are updated according to the update data, the first software and the second software can be activated also in the +B state because they are installed in one first ECU. On the other hand, since the third software that operates in the IG state is installed in the second ECU, when the power source state transitions to the IG state, installation of the third software starts according to the update data and the third software is activated. In a situation where the second software of the first ECU has already been activated in the +B state, the second software issues a command to the third software of the second ECU when the power source state transitions to the IG state, in some cases. However, the installation of the third software in the second ECU has just started and the third software may not understand the command issued by the second software in the first ECU, which may result in the predetermined system not operating.

For example, the first ECU is a door ECU and the second ECU is a sensor ECU. For example, the first software is door lock software for controlling door locks, the second software is window software for controlling power windows, and the third software is raindrop detection software for a sensor that detects raindrops. The predetermined system is a rainy weather window closing system that closes the windows when it rains.

In this case, if the door lock software and window software in the door ECU are updated according to the update data, the door lock software and window software can be activated even in the +B state because they are installed in the door ECU. On the other hand, since rain detection software that operates in the IG state is installed in the sensor ECU, when the power source state transitions to the IG state, the installation of the rain detection software starts according to the update data and activation is performed. Since the window software of the door ECU has already been activated in the +B state, the window software may issue a command to the rain detection software in the sensor ECU when the power source state has transitioned to the IG state. However, the installation of the rain detection software of the sensor ECU has just started and the sensor ECU may not able to understand the command issued by the window software of the door ECU, resulting in the rainy weather window closing system not operating. For example, there has been a risk that the windows will not close in rainy weather.

Specific control content in the update management system 1 will be described below with reference to FIGS. 1 to 6 as appropriate.

### Functions of Update Management Device

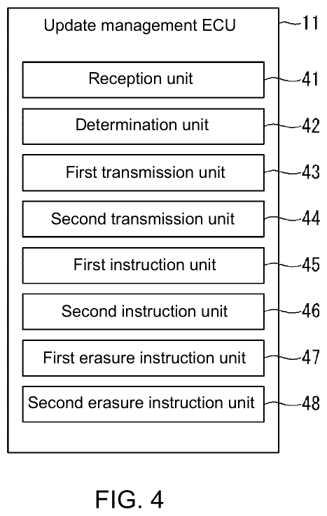

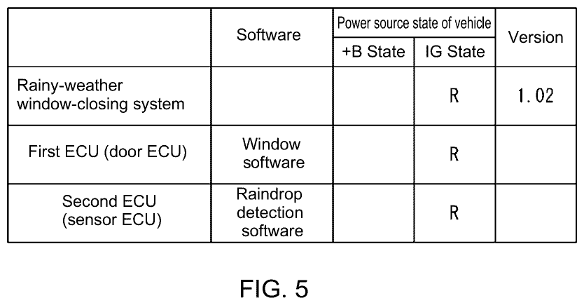

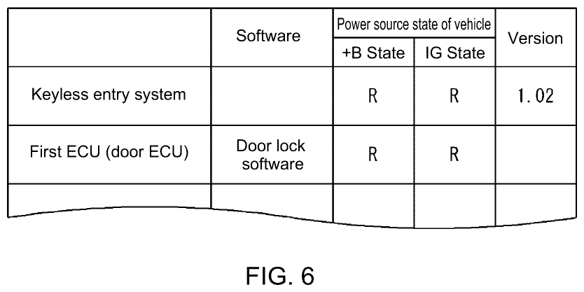

FIG. 4 is a functional block diagram showing functions included in the update management ECU 11 according to the first embodiment. FIGS. 5 and 6 are diagrams showing examples of ECU tables that list ECUs. The update management ECU 11 includes a reception unit 41, a determination unit 42, a first transmission unit 43, a second transmission unit 44, a first instruction unit 45, a second instruction unit 46, a first erasure instruction unit 47, and a second erasure instruction unit 48. Note that “R” shown in FIGS. 5 and 6 indicates that the system or software operates in that power source state.

### Reception Unit

The reception unit 41 receives, from an external device outside the vehicle, first update data for updating first software that operates in the first power source state and the second power source state, and second update data for updating second software that does not operate in the first power source state but operates in the second power source state.

Specifically, the reception unit 41 has a function of downloading the first update data and the second data from the server 2. The server 2 is provided, for example, in a data center of a vehicle manufacturer. The server 2 stores, for example, update data for updating the software of each ECU. The first update data is update data for installing door lock software, which is the +B software of the first ECU 12. The second update data is update data for installing the window software, which is the IG software of the first ECU 12.

The reception unit 41 operates the control unit 22 to access the server 2 via the internal bus 24, the transceiver 25a, the communication device 15, and the network 3, and downloads the update data stored in the server 2. The download is started, for example, when new update data is recorded in the server 2. In this case, the server 2 transmits, to each update management system 1, information indicating that update data has been newly recorded. The information indicating that update data has been newly recorded may include information indicating the version of the newly recorded update data. Hereinafter, the information indicating that update data has been newly recorded will be referred to as update software information. For example, an example in which update data is newly recorded in the server 2 may be a case where the window software of the first ECU 12 and the raindrop detection software of the second ECU 13 for realizing a rainy-weather window-closing system are updated due to rainfall sensitivity improving compared to the previous rain sensor.

The update management ECU 11 of each update management system 1 stores, for example, an ECU table as shown in FIG. 5 in the storage unit 23. For example, the ECU table includes information indicating a predetermined system, the ECUs and software that execute the predetermined system, the power source state in which the software operates, and the version of the software of the ECUs, and is recorded in the storage unit 23 in the form of a table for each predetermined system. An example of the predetermined system is a rainy-weather window-closing system. As shown in FIG. 5, the ECUs and software that perform this function are the window software of the door ECU and the rain detection software of the sensor ECU. The window software and the raindrop detection software are pieces of software that operate when the power source state is the IG state. The version of the software is, for example, 1.02. In this example, the rainy-weather window closing system is realized by the IG drive software, and therefore the system operates in the IG state overall.

Note that although the ECU table is described as being stored in the storage unit 23 of the update management ECU 11, there is no limitation to this. For example, the ECU table may also be stored in the storage unit of the server 2.

FIG. 6 shows another example of an ECU table. In this example, the predetermined system is, for example, a keyless entry system. The ECUs and software that execute the predetermined system are, for example, door lock software of a door ECU and software of an ECU that cooperates with the door lock software. Since the keyless entry system operates in the +B state, the software of each ECU also operates in the +B state.

For example, the reception unit 41 compares the version information included in the updated software information sent from the server with the version information recorded in the ECU table, and determines whether or not the software has been updated. If it is determined that the software has been updated, the reception unit 41 requests the update data from the server 2 and downloads the update data. For example, the reception unit 41 temporarily records the downloaded update data in the storage unit 23.

Note that the reception unit 41 may also receive the first update data and the second update data from an external device while the power source state is the first power source state. For example, update data for updating the door lock software, which is the +B software, and the window software, which is the IG software, may also be downloaded during the +B state, that is, at a time the vehicle is in a state of not being able to travel, for example, while the vehicle is stopped, By downloading the update data while the vehicle is stopped, it is possible to quickly start transmitting the update data, installing the IG software, and the like to ECUs in which the +B software is not installed but the IG software is installed, when the power source state transitions to the IG state.

### Determination Unit

The determination unit 42 has a function of determining whether the power source state of the vehicle is the first power source state or the second power source state.

Specifically, the determination unit 42 detects the power source state of the vehicle, for example, and determines whether the detected power source state is the +B state or the IG state. The power source state of the vehicle may be detected by the update management ECU 11 or by a power source monitoring ECU (not shown) that monitors the power source state of the vehicle. In the detection of the power source state, in the case of the +B state, for example, the voltage of a power source bus connected to an electrical device that receives a supply of power directly from the battery of the vehicle is detected, and if the voltage is a predetermined voltage or more, it is determined that the power source state is the +B state. In the case of the IG state, for example, the voltage of the power source bus that supplies power to the ECU that operates when the vehicle starts traveling when the accelerator is depressed, such as an engine control ECU, is detected, and if the voltage is a predetermined voltage or more, it is determined that the power source state is the IG state. Note that when the power source state is the +B state and the IG state, it is determined that the power source state is the IG state.

### First Transmission Unit

The first transmission unit has a function of, when the determination unit determines that the power source state of the vehicle is the first power source state, transmitting the first update data to the in vehicle device including a first storage unit and a second storage unit, so that the in vehicle device installs the updated first software in the first storage unit and activates the updated first software.

In the case of FIGS. 5 and 6, when the determination unit 42 determines that the power source state of the vehicle is the +B state, the first transmission unit 43 transmits update data for installing door lock software, which is the +B software, to the door ECU, which is the first ECU 12.

For example, the first transmission unit 43 operates the control unit 22 to execute the function of the first transmission unit 43. First, the control unit 22 reads out the first update data that has been temporarily stored. Next, the control unit 22 transmits the read out first update data to the communication bus 14b via the transceiver 25b. The first update data transmitted to the communication bus 14b arrives at the transceiver 35 of the first ECU 12. The first ECU 12 is operated by the control unit 32, and the control unit 32 receives the update data that has arrived, via the transceiver 35. The control unit 32 temporarily stores the received update data in the first storage unit 33 or a random access memory (RAM) (not shown).

When the first transmission unit 43 transmits the first update data, the first ECU 12 installs the +B software in the first storage unit 33 based on the received first update data. For example, the door ECU installs door lock software in the first storage unit 33.

For example, when the first update data is transmitted from the first transmission unit 43, after completion of reception of the transmitted update data, the control unit 32 of the first ECU 12 installs the software in the first storage unit 33 based on the temporarily stored update data.

In another example, when the first transmission unit transmits the first update data, the update management ECU 11 transmits, to the first ECU 12, a first installation instruction, which is an instruction to install the +B software in the first storage unit 33 using the first update data. Upon receiving the first installation instruction, the first ECU 12 installs the +B software.

### Second Transmission Unit

The second transmission unit has a function of, when the determination unit determines that the power source state of the vehicle is the second power source state, transmitting the first update data and the second update data to the in-vehicle device so that the in-vehicle device installs the updated first software and the updated second software in the second storage unit and activates the updated first software and the updated second software.

In the case of FIGS. 5 and 6, when the determination unit 42 determines that the power source state of the vehicle is the IG state, the second transmission unit 44 transmits, to the door ECU, which is the first ECU 12, the first update data and the second update data for installing the door lock software, which is the +B software, and the window software, which is the IG software.

For example, the second transmission unit 44 operates the control unit 22 to execute the function of the second transmission unit 44. First, the control unit 22 reads out the first update data temporarily stored in the storage unit 23. Next, the control unit 22 transmits the read out first update data to the communication bus 14b via the transceiver 25b. The first update data transmitted to the communication bus 14b arrives at the transceiver 35 of the first ECU 12. The first ECU 12 is operated by the control unit 32, and the control unit 32 receives the update data that has arrived, via the transceiver 35. The control unit 32 temporarily stores the received update data in the first storage unit 33 or a RAM (not shown).

When the second transmission unit transmits the first update data and the second update data, the first ECU 12 installs the +B software and the IG software in the second storage unit 34 based on the received first update data and second update data. For example, the door ECU installs door lock software and window software in the second storage unit 34.

When the first update data and the second update data are transmitted from the second transmission unit 44, the first ECU 12 temporarily stores the transmitted first update data and second update data in the second storage unit 34, for example. After the transmitted update data has been received, the control unit 32 of the first ECU 12 may install software based on the update data temporarily stored in the second storage unit 34.

In another example, when the second transmission unit transmits the first update data and the second update data, the update management ECU 11 transmits, to the first ECU 12, a second installation instruction, which is an instruction to install the +B software and the IG software in the second storage unit 34 according to the first update data and the second update data. Then, upon receiving the second installation instruction, the first ECU 12 may install the +B software and the IG software.

### First Instruction Unit

The first instruction unit 45 has a function of, when the determination unit determines that the power source state of the vehicle is the first power source state, transmitting a first activation instruction for activating the updated first software installed in the first storage unit to the in-vehicle device.

In the example of FIG. 6, that is, in the case of a keyless entry system that is operated in the +B state, when the determination unit 42 determines that the power source state is in the +B state, the first instruction unit 45 transmits an activation instruction to activate the door lock software, which is the +B software.

Specifically, the first instruction unit 45 refers to the ECU tables stored in the storage unit 23, for example, the contents shown in FIGS. 5 and 6. From the referenced ECU table, the first instruction unit 45 obtains information indicating the power source state in which the software operates to execute the system. In the example of FIG. 6, the door lock software that executes the keyless entry system operates in both the +B state and the IG state, and therefore when the power source state is the +B state, the first instruction unit 45 transmits, to the door ECU, a first activation instruction for activating the updated door lock software installed in the first storage unit 33. On the other hand, since the +B software is not listed in FIG. 5, the first instruction unit 45 does not transmit the first activation instruction.

Note that the first activation instruction may be transmitted to the in-vehicle device after the software is installed according to the update data. This is because the software cannot be activated during installation. For example, the first instruction unit 45 is configured to wait for a predetermined time before transmitting. In another example, after the installation of the software is completed, the in-vehicle device transmits installation completion information indicating that the installation of the software is complete, to the update management device. Then, when the installation completion information is received, the first instruction unit 45 transmits the first activation instruction.

Note that in one example, the first ECU 12 is configured to operate the control unit 32 (first activation unit 32a) and activate the first software installed in the first storage unit 33 when a first activation instruction transmitted by the first instruction unit 45 is received.

### Second Instruction Unit

The second instruction unit 46 has a function of, when the determination unit determines that the power source state of the vehicle is the second power source state, transmitting a second activation instruction for activating the updated first software and the updated second software installed in the second storage unit, to the in-vehicle device.

In the examples of FIGS. 5 and 6, when the determination unit 42 determines that the power source state is the IG state, the second instruction unit 46 transmits, to the door ECU, a second activation instruction for activating the window software, which is the IG software, for the rainy weather window closing system. In addition, the second instruction unit 46 transmits, to the sensor ECU, a second activation instruction for activating the raindrop detection software. In addition, the second instruction unit 46 transmits, to the door ECU, a second activation instruction for activating the door lock software, which is the +B software, for the keyless entry system.

Specifically, the second instruction unit 46 refers to the ECU tables stored in the storage unit 23, the contents of which are shown in FIGS. 5 and 6. From the referenced ECU tables, the second instruction unit 46 obtains information indicating the power source state in which the software operates to execute the system. In the example of FIG. 5, the rainy weather window closing system is executed by window software and raindrop detection software operating in the IG state, and therefore when the power source state is the IG state, the second instruction unit 46 transmits, to the door ECU, a second activation instruction for activating the updated window software installed in the second storage unit 34. In addition, since the door lock software that executes the keyless entry system operates in both the +B state and the IG state, when the power source state is the IG state, the second instruction unit 46 transmits, to the door ECU, a second activation instruction for activating the updated door lock software installed in the second storage unit 34. In addition, the update management device may transmit an activation instruction for activating the raindrop detection software to the sensor ECU as well.

Note that for the same reason as for the first instruction unit, the second instruction unit may also transmit the second activation instruction to the in vehicle device after the software has been installed according to the update data.

Note that in one example, the first ECU 12 is configured to operate the control unit 32 (second activation unit 32b) and activate the first software and the second software installed in the second storage unit 34, when a second activation instruction transmitted by the second instruction unit 46 is received.

### First Erasure Instruction Unit

The first erasure instruction unit 47 has a function of, when the pre-update first software and the pre-update second software have been installed in the second storage unit and the updated first software has been installed in the first storage unit, transmitting a first erasure instruction for erasing the pre update first software and the pre-update second software from the second storage unit, to the in-vehicle device.

Specifically, the control unit 22 transmits a first erasure instruction to the communication bus 14b via the transceiver 25b. The transmitted first erasure instruction reaches the transceiver 35 of the first ECU 12 via the communication bus 14b. The first erasure instruction that has reached the transceiver 35 is received by the control unit 32 of the first ECU 12. According to the received first erasure instruction, the control unit 82 erases the pre update first software and the pre-update second software installed in the second storage unit 34.

Due to the pre-update software being erased from the second storage unit 34, the second storage unit 34 becomes empty, and when software is installed later, the risk of remnants of the pre-update software adversely affecting the later-installed software can be suppressed. Note that if there is no particular problem with installing over the pre-update software, the transmission of the first erasure instruction can be skipped.

Note that the pre update software installed in the second storage unit 34 may also be deleted after the software is installed in the first storage unit 33 and activated. This is because if the pre-update software installed in the second storage unit 34 was being executed until immediately before activation, it can be instantly swapped with the software in the first storage unit 33.

### Second Erasure Instruction Unit

The second erasure instruction unit 48 has a function of, when the updated first software has been installed in the first storage unit and the updated first software and the updated second software have been installed in the second storage unit, transmitting a second erasure instruction for erasing the updated first software from the first storage unit, to the in-vehicle device.

Specifically, the control unit 22 transmits a second erasure instruction to the communication bus 14b via the transceiver 25b. The transmitted first erasure instruction reaches the transceiver 35 of the first ECU 12 via the communication bus 14b. The second erasure instruction that has reached the transceiver 35 is received by the control unit 32 of the first ECU 12. The control unit 32 erases the updated first software installed in the first storage unit 33 according to the received second erasure instruction.

If the updated first software has been installed in the first storage unit 33, when the updated first software and the updated second software are installed in the second storage unit 34, the updated first software installed in the first storage unit 33 may also be erased.

This is performed to empty the first storage unit 33 because the updated first software installed in the first storage unit 33 will not be executed after the updated first software and the updated second software are installed in the second storage unit 34.

Note that the updated software installed in the first storage unit 33 may also be erased after the software is installed in the second storage unit 34 and activated. This is because if the first software installed in the first storage unit was being executed until immediately before activation, it can be instantly swapped with the software in the second storage unit 34.

### Control Method

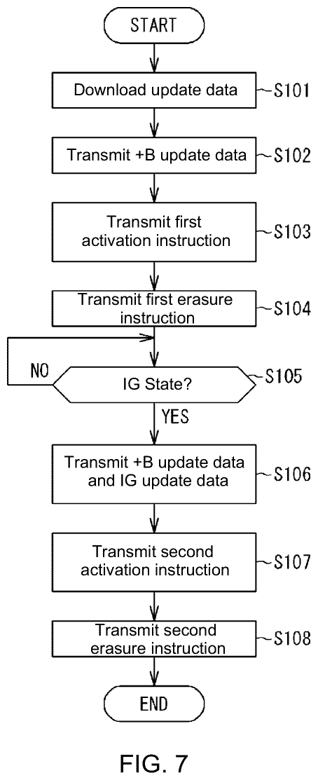

FIG. 7 is a flowchart showing an example of a control method executed by the update management ECU 11 according to the first embodiment. The order of the steps shown in FIG. 7 may be changed as appropriate. A series of control methods will be described with reference to FIG. 7. Note that in the following description, the initial state is assumed to start from a state in which the vehicle cannot travel. Accordingly, in the initial state, the power source state of the vehicle is the +B state.

Note that the control executed by the update management ECU 11 is executed by the information processing unit 21. When the information processing unit 21 executes such control, the control unit 22 reads out a computer program from the storage unit 23 and executes various types of computation and processing.

The control executed by the first ECU 12 is executed by the information processing unit 31. When the information processing unit 31 executes such control, the control unit 32 reads out a computer program from the first storage unit 33 and executes various types of computation and processing.

### Step S101

First, the reception unit 41 of the update management ECU 11 downloads the update data from the server 2 (step S101). Specifically, the first update data for updating the first software that operates in the first power source state and the second power source state and the second update data for updating the second software that does not operate in the first power source state but operates in the second power source state are received from an external device outside of the vehicle. After the reception is complete, the update management ECU 11 proceeds to step S102.

Specifically, the reception unit 41 of the update management ECU 11 downloads the first update data and the second data from the server 2. The server 2 stores update data for each ECU. The first update data is update data for installing the +B software. The second update data is update data for installing the IG software. The update management ECU 11 accesses the server 2 via the communication bus 14a, the transceiver 25a, the communication device 15, and the network 3, and downloads the update data stored in the server 2.

For example, when update data is newly recorded in the server 2, the server 2 transmits, to the update management system 1, update software information including information indicating that the update data has been newly recorded. The update software information may also include information indicating the version of the newly recorded update data.

The update management ECU 11 of the update management system 1 stores, for example, an ECU table as shown in FIG. 5 in the storage unit 23. In the ECU table, information indicating a predetermined system, the ECU and software that execute the predetermined system, the power source state in which the software operates, and the version of the software of the ECU is recorded in the form of a table for each predetermined system.

For example, the reception unit 41 of the update management ECU 11 compares the updated software information (including information indicating the version) sent from the server with the ECU tables recorded in the storage unit 23, and determines whether the software has been updated. For example, the versions of software are compared to determine whether the software has been updated. If it is determined that the software has been updated, the reception unit 41 requests the update data from the server 2 and downloads the update data. For example, the reception unit 41 temporarily records the downloaded update data in the storage unit 23. After the download is complete, the processing proceeds to step S102.

### Step S102

Next, when the determination unit determines that the power source state of the vehicle is the first power source state, the update management ECU 11 transmits the first update data to the in vehicle device including a first storage unit and a second storage unit, so that the in-vehicle device installs the updated first software in the first storage unit and activates the updated first software (step S102). As described above, the initial state of the power source state is the +B state, and therefore step S102 is executed. Then, the update management ECU 11 proceeds to step S103.

In the case of FIGS. 5 and 6, the +B software is door lock software for the first ECU 12, and therefore the first transmission unit 43 of the update management ECU 11 transmits first update data for installing the door lock software to the first ECU 12. The first ECU 12 includes a first storage unit 33 and a second storage unit 34, and the update data is to be installed in the first storage unit 33 and activated.

When the first transmission unit 43 of the first ECU 12 receives the first update data, the first ECU 12 installs the +B software in the first storage unit 33 according to the received first update data. In the case of FIGS. 5 and 6, the door ECU installs the door lock software in the first storage unit 33.

### Step S103

Next, when the determination unit determines that the power source state of the vehicle is the first power source state, the first instruction unit 45 transmits, to the in-vehicle device, a first activation instruction for activating the updated first software installed in the first storage unit (step S103). As described above, the initial state of the power source state is the +B state, and therefore step S103 is executed, Then, the update management ECU 11 proceeds to step S104.

In the case of FIGS. 5 and 6, for the keyless entry system executed in the +B state, the first activation instruction is an activation instruction for activating the door lock software, which is the +B software. The first instruction unit 45 transmits the first activation instruction to the first ECU 12.

Specifically, the first instruction unit 45 refers to the ECU tables stored in the storage unit 23, for example, the contents shown in FIGS. 5 and 6. From the referenced ECU table, the first instruction unit 45 obtains information indicating the power source state in which the software operates to execute the system. In the example of FIG. 6, the door lock software that executes the keyless entry system operates in both the +B state and the IG state, and therefore when the power source state is the +B state, the first instruction unit 45 transmits, to the door ECU, a first activation instruction for activating the updated door lock software installed in the first storage unit 33. On the other hand, since the +B software is not listed in FIG. 5, the first instruction unit 45 does not transmit the first activation instruction.

Note that the first activation instruction may be transmitted to the in-vehicle device after the software is installed according to the update data.

When the first ECU 12 receives the first activation instruction, the first ECU 12 activates the first software installed in the first storage unit 33.

### Step S104

Next, when the pre-update first software and the pre-update second software have been installed in the second storage unit and the updated first software has been installed in the first storage unit, the first erasure instruction unit 47 transmits a first erasure instruction for erasing the pre update first software and the pre-update second software from the second storage unit, to the in-vehicle device (step S104). Then, the update management ECU 11 proceeds to step S105.

Specifically, the control unit 22 transmits a first erasure instruction to the communication bus 14b via the transceiver 25b. The first erasure instruction transmitted via the communication bus 14b reaches the transceiver 35 of the first ECU 12. The first erasure instruction that has reached the transceiver 35 is received by the first ECU 12. According to the received first deletion instruction, the control unit 32 erases the pre update first software and the pre-update second software installed in the first storage unit 33.

Note that the pre-update software installed in the second storage unit 34 may also be deleted after the software is installed in the first storage unit 33 and activated. Also, if there is no particular problem with installing over the pre-update software, this step can be skipped.

### Step S105

Next, the determination unit 42 of the update management ECU 11 determines whether the power source state of the vehicle is the first power source state or the second power source state (step S105). If the determination unit determines that the power source state of the vehicle is the second power source state, that is, the IG state, the update management ECU 11 proceeds to step S106. On the other hand, if the determination unit determines that the power source state of the vehicle is the first power source state, that is, the +B state, the update management ECU 11 returns to step S105 and repeats step S105. That is, the update management ECU 11 is waiting for the power source state of the vehicle to change from the +B state to the IG state.

### Step S106

Next, when the determination unit determines that the power source state of the vehicle is the second power source state, the second transmission unit of the update management ECU 11 transmits the first update data and the second update data to the in-vehicle device so that the in vehicle device installs the updated first software and the updated second software in the second storage unit and activates the updated first software and the updated second software (step S106). Then, the update management ECU 11 proceeds to step S107.

In the case of FIGS. 5 and 6, when the determination unit 42 determines that the power source state of the vehicle is the IG state, that is, when the power source state of the vehicle has transitioned from the +B state to the IG state, the second transmission unit 44 transmits, to the door ECU, first update data for installing door lock software, which is the +B software, and second update data for installing window software, which is the IG software.

When the first ECU 12 receives the first update data and the second update data, the first ECU 12 installs the +B software and the IG software in the second storage unit 34 according to the received first update data and second update data. For example, the door ECU installs the door lock software and the window software in the second storage unit 34.

### Step S107

Next, when the determination unit determines that the power source state of the vehicle is the second power source state, the second instruction unit 46 of the update management ECU 11 transmits, to the in-vehicle device, a second activation instruction for activating the updated first software and the updated second software installed in the second storage unit (step S107). Then, the update management ECU 11 proceeds to step S108.

In the examples of FIGS. 5 and 6, when the determination unit 42 determines that the power source state is the IG state, the second instruction unit 46 transmits a second activation instruction for activating the window software, which is the IG software, for the rainy weather window-closing system. Also, the second instruction unit 46 transmits a second activation instruction for activating the door lock software, which is the +B software, for the keyless entry system. In addition, the update management device may transmit an activation instruction for activating the raindrop detection software to the sensor ECU as well.

Note that the second activation instruction may be transmitted to the in-vehicle device after the software is installed by the update data.

When the in-vehicle device receives the second activation instruction, the in-vehicle device activates the first software and the second software installed in the second storage unit. In the case of FIGS. 5 and 6, upon receiving the second activation instruction, the door ECU activates the window software and the door lock software installed in the second storage unit 34. In addition, the rain detection software of the sensor ECU may also be activated. This is because the rainy-weather window closing system is executed due to the window software and the raindrop detection software cooperating with each other.

### Step S108

Next, when the updated first software has been installed in the first storage unit and the updated first software and the updated second software have been installed in the second storage unit, the second erasure instruction unit 48 of the update management ECU transmits, to the in-vehicle device, a second erasure instruction for erasing the updated first software from the first storage unit (step S108). Thereafter, the update management ECU 11 ends the series of processes.

Note that the updated software installed in the first storage unit 33 may also be erased after the software is installed in the second storage unit 34 and activated. Also, if there is no particular need to use the first storage unit 33 in the future, this step may be skipped.

### Control Sequence

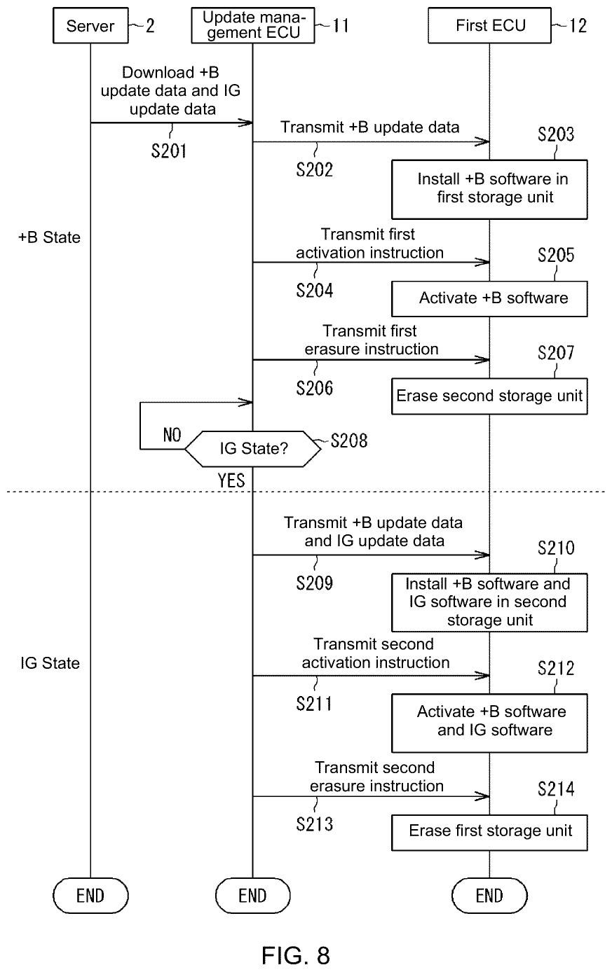

Next, the control sequence of the update management system 1 will be described. FIG. 8 is a sequence diagram of the update management system according to the first embodiment. Note that in the following description, the initial state is assumed to start from a state in which the vehicle cannot travel, Accordingly, in the initial state, the power source state of the vehicle is the +B state. The power source state then transitions from the +B state to the IG state.

### Step S201

First, the reception unit 41 of the update management ECU 11 downloads the update data from the server 2 (step S201). Specifically, the first update data for updating the first software that operates in the first power source state and the second power source state and the second update data for updating the second software that does not operate in the first power source state but operates in the second power source state are received from an external device outside the vehicle. After the reception is completed, the update management system 1 proceeds to step S202.

Specifically, the reception unit 41 of the update management ECU 11 downloads the first update data and the second data from the server 2. The server 2 stores update data for each ECU. The first update data is update data for installing the +B software. The second update data is update data for installing the IG software. The update management ECU 11 accesses the server 2 via the communication bus 14a, the transceiver 25a, the communication device 15, and the network 3, and downloads the update data stored in the server 2.

### Step S202

Next, when the determination unit determines that the power source state of the vehicle is the first power source state, the update management ECU 11 transmits the first update data to the in-vehicle device, which has a first storage unit and a second storage unit, so that the in-vehicle device installs the updated first software in the first storage unit and activates the updated first software (step S202). As described above, since the initial state of the power source state is the +B state, step S202 is executed. The update management system 1 then proceeds to step S203.

In the case of FIGS. 5 and 6, the +B software is door lock software for the first ECU 12, and therefore the first transmission unit 48 of the update management ECU 11 transmits first update data for installing the door lock software to the first ECU 12. The first ECU 12 includes the first storage unit 33 and the second storage unit 34, and the update data is to be installed in the first storage unit 33 and activated.

### Step S203

Next, when the first transmission unit 43 transmits the first update data, the first ECU 12 installs the +B software in the first storage unit 33 based on the received first update data (step S203). In the case of FIGS. 5 and 6, the door ECU installs the door lock software in the first storage unit 33. After the installation, the update management ECU 11 proceeds to step S204.

### Step S204

Next, when the determination unit determines that the power source state of the vehicle is the first power source state, the first instruction unit 45 transmits, to the in vehicle device, a first activation instruction for activating the updated first software installed in the first storage unit (step S204). As described above, the initial state of the power source state is the +B state, and therefore step S204 is executed. Then, the update management system 1 then proceeds to step S205.

In the example of FIGS. 5 and 6, that is, in the case of a keyless entry system executed in the +B state, the first activation instruction is an activation instruction to activate the door lock software, which is the +B software. The first instruction unit 45 transmits the first activation instruction to the first ECU 12.

### Step S205

Next, if the first ECU 12 receives the first activation instruction, the first activation unit activates the first software installed in the first storage unit 33 (step S205). Then, the update management system 1 proceeds to step S206.

### Step S206

Next, when the pre-update first software and the pre-update second software have been installed in the second storage unit and the updated first software has been installed in the first storage unit, the first erasure instruction unit 47 transmits a first erasure instruction for erasing the pre-update first software and the pre-update second software from the second storage unit, to the in vehicle device (step S206), Then, the update management ECU 11 proceeds to step S207.

### Step S207

Next, when the first ECU 12 receives the first erasure instruction, the control unit 32 erases the pre-update first software and the pre-update second software installed in the first storage unit 33 according to the received first erasure instruction (step S207). Then, the update management system 1 proceeds to step S208.

Note that if there is no risk of problems occurring even if the pre update first software and the pre-update second software are not erased, steps S206 and S207 may be skipped.

### Step S208

Next, the determination unit 42 of the update management ECU 11 determines whether the power source state of the vehicle is the first power source state or the second power source state (step S208). If the determination unit 42 determines that the power source state of the vehicle is the second power source state, that is, the IG state, the update management system 1 proceeds to step S209, On the other hand, if the determination unit determines that the power source state of the vehicle is the first power source state, that is, the +B state, the update management system 1 returns to step S208 and repeats step S208. That is, the update management system 1 is waiting for the power source state of the vehicle to change from the +B state to the IG state. Accordingly, after step S209, the power source state has transitioned from the +B state to the IG state.

### Step S209

Next, when the determination unit determines that the power source state of the vehicle is the second power source state, the second transmission unit of the update management ECU 11 transmits the first update data and the second update data to the in-vehicle device so that the in vehicle device installs the updated first software and the updated second software in the second storage unit and activates the updated first software and the updated second software (step S209). Then, the update management ECU 11 proceeds to step S210.

In the case of FIGS. 5 and 6, when the determination unit 42 determines that the power source state of the vehicle is the IG state, that is, when the power source state of the vehicle has transitioned from the +B state to the IG state, the second transmission unit 44 transmits, to the door ECU, first update data for installing door lock software, which is the +B software, and second update data for installing window software, which is the IG software.

### Step S210

When the first ECU 12 receives the first update data and the second update data transmitted by the second transmission unit, the first ECU 12 installs the +B software and the IG software in the second storage unit 34 according to the received first update data and second update data (step S210). In the case of FIGS. 5 and 6, the door ECU installs the door lock software and the window software in the second storage unit 34. Then, the update management system 1 proceeds to step S211.

### Step S211

Next, when the determination unit determines that the power source state of the vehicle is the second power source state, the second instruction unit 46 of the update management ECU 11 transmits, to the in-vehicle device, a second activation instruction for activating the updated first software and the updated second software installed in the second storage unit (step S211), Then, the update management ECU 11 proceeds to step S212.

In the examples of FIGS. 5 and 6, when the determination unit 42 determines that the power source state is the IG state, the second instruction unit 46 transmits a second activation instruction for activating the window software, which is the IG software, for the rainy weather window closing system. Also, the second instruction unit 46 transmits a second activation instruction for activating the door lock software, which is the +B software, for the keyless entry system. In addition, the update management device may transmit an activation instruction for activating the raindrop detection software to the sensor ECU as well.

### Step S212

Next, if the first ECU 12 receives the second activation instruction, the first ECU 12 activates the first software and the second software installed in the second storage unit 34 (step S212). Then, the update management system proceeds to step S213.

### Step S213

Next, when the updated first software has been installed in the first storage unit and the updated first software and the updated second software have been installed in the second storage unit, the second erasure instruction unit 48 of the update management ECU transmits a second erasure instruction for erasing the updated first software from the first storage unit, to the in-vehicle device (step S213). Then, the update management system proceeds to step S214.

### Step S214

Next, when the first ECU 12 receives the second erasure instruction, the control unit 32 erases the updated first software installed in the first storage unit 33 according to the received second erasure instruction (step S214). Then, the update management system 1 ends the series of processes.

Note that if there is no risk of problems occurring even if the updated first software is not erased, steps S213 and S214 may be skipped.

### Summary

A vehicle is known which has a plurality of power source states including a +B state, an IG state, and the like, and in which a plurality of ECUs are mounted. In such a vehicle, if the ECU software is updated, there is a risk that multiple pieces of software that cooperate to execute a predetermined system may be activated in different power source states, which can result in one piece of software not being able to understand a command issued by the other piece of software, resulting in the predetermined system not operating.

According to this embodiment, the update management device transmits, to the in-vehicle device, update data for installing and activating software alternatingly in two storage units of the in vehicle device depending on the power source state of the vehicle. The update management device then installs software in the in-vehicle device according to the update data depending on the power source state of the vehicle, and activates the software depending on the power source state of the vehicle. As a result, the software of the in-vehicle device is updated and activated sequentially at an appropriate time depending on the power source state, whereby a function that operates due to cooperation between the software of a plurality of ECUs operates without any discrepancies.

Also, if the +B software and the IG software are installed in the first ECU, the IG software is installed in the second ECU, and the IG software of the first ECU and the IG software of the second ECU cooperate to execute a predetermined system, activation instructions for instructing activation may be sent simultaneously to the IG software of the first ECU and the IG software of the second ECU. The IG software of the first ECU and the IG software of the second ECU are explicitly activated simultaneously, which further reduces discrepancies such as the IG software of the first ECU not being able to understand commands issued by the IG software of the second ECU.

Note that although the in-vehicle device has been described as including the first storage unit and the second storage unit, there is no limitation to this. The in-vehicle device may also include an additional storage unit.

### Second Embodiment

### Details of Second Embodiment of the Present Disclosure

Hereinafter, a second embodiment of the present disclosure will be described in detail with reference to the drawings.

The differences between the first embodiment and the second embodiment are as follows. In the first embodiment, software is installed alternatingly in two storage units provided in the in-vehicle device according to the first update data for updating the first software and the second update data for updating the second software. On the other hand, in the second embodiment, the update management device creates composite update data from the first update data and the second update data in advance, and installs software in one storage unit of the in vehicle device according to the composite update data. All other respects are the same. The same configurations as those in the first embodiment are denoted by the same reference numerals, and descriptions of the same components, functions, and operations will be omitted.

### Configuration of Update Management System

The configuration of the update management system in the second embodiment is the same as that in the first embodiment. Note that the in-vehicle device does not necessarily need to have two storage units, and may have only one storage unit.

### Problems to be Solved by the Present Embodiment

The problem that the second embodiment aims to solve is the same as that of the first embodiment. However, if the in-vehicle device has only one storage unit, the first embodiment is not applicable. In view of this, an object of the present disclosure is to solve this problem even when there is only one storage unit.

In view of this, in this embodiment, the update management device is sn update management device for managing update of software of an in-vehicle device in a vehicle having a plurality of power source states including a first power source state and a second power source state different from the first power source state, the update management device including: a reception unit configured to receive, from an external device outside the vehicle, first update data for updating first software that operates in the first power source state and the second power source state, and second update data for updating second software that does not operate in the first power source state but operates in the second power source state; a compositing unit configured to create, from the first update data and the second update data, composite update data for installing composite software including a first function that is a function of the updated first software and a second function that is a function of the updated second software; and a transmission unit configured to transmit the composite update data to the in vehicle device including a storage unit, so that the in-vehicle device installs the composite software in the storage unit, activates the first function when the power source state of the vehicle is the first power source state, and activates the second function when the power source state of the vehicle is the second power source state.

With this configuration, the update management device creates composite update data from two pieces of update data for updating two pieces of software, and transmits, to the in-vehicle device, update data for installing the composite update data in the storage unit of the in-vehicle device and activating the composite update data depending on the power source state of the vehicle. As a result, the software of the in-vehicle device is updated and activated sequentially at an appropriate time depending on the power source state, whereby a function that operates due to cooperation between the software of a plurality of ECUs operates without any discrepancies.

The update management device further includes: a determination unit configured to determine whether the power source state of the vehicle is the first power source state or the second power source state; a first instruction unit configured to, when the determination unit determines that the power source state of the vehicle is the first power source state, transmit a first activation instruction for activating the first function to the in-vehicle device; and a second instruction unit configured to, when the determination unit determines that the power source state of the vehicle is the second power source state, transmit a second activation instruction for activating the second function to the in-vehicle device.

With this configuration, the update management device causes the in-vehicle device to activate software depending on the power source state of the vehicle. As a result, the software of the in vehicle device is updated and activated sequentially at an appropriate time depending on the power source state, whereby a function that operates due to cooperation between the software of a plurality of ECUs operates without any discrepancies.

### Functions of Update Management Device

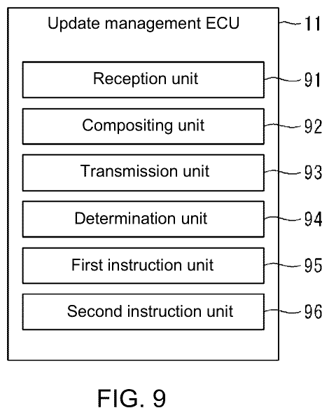

FIG. 9 is a functional block diagram showing functions included in the update management ECU 11 according to the second embodiment. The update management ECU 11 includes a reception unit 91, a compositing unit 92, a transmission unit 93, a determination unit 94, a first instruction unit 95, and a second instruction unit 96. A significant difference from the first embodiment is that the compositing unit 92 is included.

### Reception Unit

The reception unit 91 has a function of receiving, from an external device outside the vehicle, first update data for updating first software that operates in the first power source state and the second power source state, and second update data for updating second software that does not operate in the first power source state but operates in the second power source state.

Specifically, the reception unit 91 has a function of downloading the first update data and the second data from the server 2. The server 2 is provided, for example, in a data center of a vehicle manufacturer. The server 2 stores, for example, update data for updating the software of each ECU. The first update data is update data for installing door lock software, which is the +B software of the first ECU 12. The second update data is update data for installing the window software, which is the IG software of the first ECU 12.

The reception unit 91 operates the control unit 22 to access the server 2 via the internal bus 24, the transceiver 25a, the communication device 15, and the network 3, and downloads the update data stored in the server 2. The download is started, for example, when update data is newly recorded in the server 2. In this case, the server 2 transmits, to each update management system 1, information indicating that update data has been newly recorded. The information indicating that update data has been newly recorded may include information indicating the version of the newly recorded update data. For example, an example in which update data is newly recorded in the server 2 may be a case where the window software of the first ECU 12 and the raindrop detection software of the second ECU 13 for realizing a rainy weather window closing system are updated due to rainfall sensitivity improving compared to the previous rain sensor.

The update management ECU 11 stores, for example, an ECU table as shown in FIG. 5. For example, the ECU table includes information indicating a predetermined system, the ECU and software that execute the predetermined system, the power source state in which the software operates, and the version of the software of the ECU, and is recorded in the storage unit 23 in the form of a table for each predetermined system. An example of the predetermined system is a rainy weather window closing system. As shown in FIG. 5, the ECUs and software that execute this function are the window software of the door ECU and the rain detection software of the sensor ECU. The window software and the raindrop detection software are pieces of software that operate when the power source state is the IG state. The version of the software is, for example, 1.02. In this example, the rainy weather window closing system is realized by the IG drive software, and therefore the system operates in the IG state overall.

Note that although the ECU table is described as being stored in the storage unit 23 of the update management ECU 11, there is no limitation to this. For example, the ECU table may also be stored in the storage unit of the server 2.

FIG. 6 shows another example of an ECU table. In this example, the predetermined system is, for example, a keyless entry system. The ECUs and software that execute the predetermined system are, for example, door lock software of a door ECU and software of an ECU that cooperates with the door lock software. Since the keyless entry system operates in the +B state, the software of each ECU also operates in the +B state.

For example, the reception unit 91 compares the version information included in the updated software information sent from the server with the version information recorded in the ECU table, and determines whether or not the software has been updated. If it is determined that the software has been updated, the reception unit 91 requests the update data from the server 2 and downloads the update data. For example, the reception unit 91 temporarily records the downloaded update data in the storage unit 23.

Note that the reception unit 91 may also receive the first update data and the second update data from an external device while the power source state is the first power source state. For example, update data for updating the door lock software, which is the +B software, and the window software, which is the IG software, may also be downloaded during the +B state, that is, at a time when the vehicle is in a state of not being able to travel, for example, while the vehicle is stopped. By downloading the update data while the vehicle is stopped, it is possible to quickly start transmitting the update data, installing the IG software, and the like to ECUs in which the +B software is not installed but the IG software is installed, when the power source state transitions to the IG state.

### Compositing Unit

The compositing unit 92 has a function of creating, from the first update data and the second update data, composite update data for installing composite software including a first function, which is a function of the updated first software and a second function, which is a function of the updated second software.

Specifically, for example, the control unit 22 reads out the first update data and the second update data downloaded from the server 2 from the storage unit 23 in which they are temporarily stored. Next, the control unit 22 adds predetermined information to the beginning and end of the data, and joins the first update data and the second update data together to create composite update data for installing the composite software. The predetermined information is, for example, information indicating the beginning of the data, information indicating the end of the data, and information indicating the transmission destination ECU. The portion of the composite update data that corresponds to the first update data includes a first function, which is the function of the updated first software, and the portion that corresponds to the second update data includes a second function, which is the function of the updated second software.

In the case of FIGS. 5 and 6, for the first ECU 12, the window software, which is the IG software, is listed in FIG. 5, and the door lock software, which is the +B software, is listed in FIG. 6. In view of this, the compositing unit 92 creates composite update data including the function of the window software and the function of the door lock software from the first update data for installing the door lock software and the second update data for installing the window software.

### Transmission Unit

The transmission unit 93 has a function of transmitting the composite update data to the in-vehicle device including a storage unit, so that the in vehicle device installs the composite software in the storage unit, activates the first function when the power source state of the vehicle is the first power source state, and activates the second function when the power source state of the vehicle is the second power source state.

Specifically, for example, the control unit 22 transmits the composite update data generated by the compositing unit to the communication bus 14b via the transceiver 25b. The transmitted composite update data propagates over the communication bus 14b and reaches the transceiver 35 of the first ECU 12. The control unit 32 receives the composite update data that has reached the transceiver 35. The control unit 32 temporarily stores the received composite update data in the first storage unit 33 or a RAM (not shown).

In the case of FIGS. 5 and 6, the transmission unit 93 transmits, to the door ECU, the composite update data created from the first update data for installing the door lock software and the second update data for installing the window software.

Note that when the first ECU 12 receives the composite update data, the first ECU 12 installs the composite software in the first storage unit 33 according to the received composite update data. For example, after the composite update data is transmitted from the transmission unit 93 and reception of the transmitted composite update data is complete, the control unit 32 of the first ECU 12 installs the composite software in the first storage unit 33 based on the temporarily-stored composite update data. In the case of FIGS. 5 and 6, the door ECU installs the door lock software and the window software in the first storage unit 33.

In another example, when the transmission unit 93 transmits the composite update data, the update management ECU 11 transmits, to the first ECU 12, an installation instruction, which is an instruction to install the composite software in the first storage unit 33 according to the composite update data. Then, upon receiving the installation instruction, the first ECU 12 installs the composite software.

### Determination Unit

The determination unit 94 has a function of determining whether the power source state of the vehicle is the first power source state or the second power source state.

Specifically, the determination unit 94 detects the power source state of the vehicle, for example, and determines whether the detected power source state is the +B state or the IG state. The power source state of the vehicle may be detected by the update management ECU 11 or by a power source monitoring ECU (not shown) that monitors the power source state of the vehicle. In the detection of the power source state, in the case of the +B state, for example, the voltage of a power source bus connected to an electrical device that receives a supply of power directly from the battery of the vehicle is detected, and if the voltage is a predetermined voltage or more, it is determined that the power source state is the +B state. In the case of the IG state, for example, the voltage of the power source bus that supplies power to the ECU that operates when the vehicle starts traveling when the accelerator is depressed, such as an engine control ECU, is detected, and if the voltage is a predetermined voltage or more, it is determined that the power source state is the IG state. Note that when the power source state is the +B state and the IG sate, it is determined that the power source state is the IG state.

### First Instruction Unit

The first instruction unit 95 has a function of, when the determination unit determines that the power source state of the vehicle is the first power source state, transmitting a first activation instruction for activating the first function to the in-vehicle device.

Specifically, the first instruction unit 95 refers to the ECU tables stored in the storage unit 23, for example, the contents shown in FIGS. 5 and 6. From the referenced ECU tables, the first instruction unit 95 obtains information indicating the power source state in which the software operates to execute the system. In the examples of FIGS. 5 and 6, the door lock software that executes the keyless entry system operates in both the +B state and the IG state. For this reason, when the power source state is the +B state, the first instruction unit 95 transmits, to the door ECU, a first activation instruction for activating the function of the door lock software of the updated composite software installed in the first storage unit 33. For example, the first ECU 12 (first activation unit 32a) is configured to activate the first function of the composite software installed in the first storage unit 33 when the first activation instruction is received.

Note that the first activation instruction may be transmitted to the in-vehicle device after the software is installed according to the update data. This is because the software cannot be activated during installation. For example, the first instruction unit 95 is configured to wait for a predetermined time before transmitting. In another example, after the installation of the software is complete, the in-vehicle device transmits installation completion information indicating that the installation of the software is complete, to the update management device. Then, when the installation completion information is received, the first instruction unit 95 transmits the first activation instruction.

### Second Instruction Unit

The second instruction unit 96 has a function of, when the determination unit determines that the power source state of the vehicle is the second power source state, transmitting a second activation instruction for activating the second function to the in-vehicle device.

In the examples of FIGS. 5 and 6, the second instruction unit 96 refers to the ECU tables stored in the storage unit 23, the contents of which are shown in FIGS. 5 and 6. From the referenced ECU table, the second instruction unit 96 obtains information indicating the power source state in which the software operates to execute the system. In the example of FIG. 5, the rainy-weather window closing system is executed by the window software and the raindrop detection software that operate in the IG state, and therefore when the power source state is the IG state, the second instruction unit 96 transmits, to the door ECU, a second activation instruction for activating the function of the updated window software installed in the first storage unit 33. In addition, the update management device may transmit an activation instruction for activating the raindrop detection software to the sensor ECU as well. Upon receiving the second activation instruction, the first ECU 12 activates the function of the updated software. For example, the first ECU 12 (second activation unit 32b) is configured to activate the function of the first software and the second software installed in the first storage unit 33 when the second activation instruction is received.

Note that for the same reason as for the first instruction unit, the second instruction unit may also transmit the second activation instruction to the in-vehicle device after the software has been installed according to the update data.

### Control Method

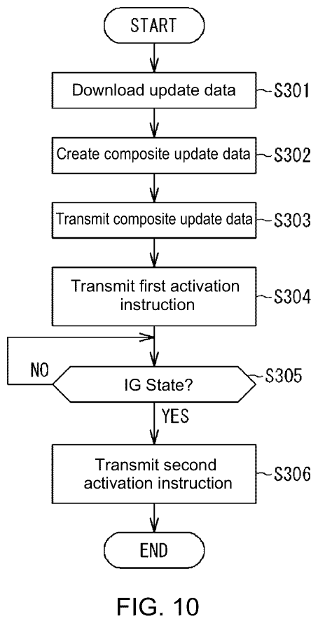

FIG. 10 is a flowchart showing an example of a control method executed by the update management ECU 11 according to the second embodiment. The order of the steps shown in FIG. 10 may be changed as appropriate. A series of control methods will be described with reference to FIG. 10. Note that in the following description, the initial state is assumed to start from a state in which the vehicle cannot travel. Accordingly, in the initial state, the power source state of the vehicle is the +B state.

Note that the control executed by the update management ECU 11 is executed by the information processing unit 21. When the information processing unit 21 executes such control, the control unit 22 reads out a computer program from the storage unit 23 and executes various types of computation and processing.

Also, the control executed by the first ECU 12 is executed by the information processing unit 31. When the information processing unit 31 executes such control, the control unit 32 reads out a computer program from the first storage unit 33 and executes various types of computation and processing.

### Step S301

First, the reception unit 91 of the update management ECU 11 receives, from an external device outside the vehicle, first update data for updating the first software that operates in the first power source state and the second power source state, and second update data for updating the second software that does not operate in the first power source state but operates in the second power source state (step S301). Then, the update management ECU 11 proceeds to step S302.

Specifically, the reception unit 91 downloads the first update data and the second data from the server 2. The server 2 is provided, for example, in a data center of a vehicle manufacturer. The server 2 stores, for example, update data for updating the software of each ECU. The first update data is update data for installing door lock software, which is the +B software of the first ECU 12. The second update data is update data for installing the window software, which is the IG software of the first ECU 12.

For example, the reception unit 91 of the update management ECU 11 compares the update software information (including information indicating the version) sent from the server with the ECU table recorded in the storage unit 23, and determines whether or not the software has been updated. For example, the versions of the software are compared to determine whether or not the software has been updated. If it is determined that the software has been updated, the reception unit 91 requests the update data from the server 2 and downloads the update data. The reception unit 91, for example, temporarily records the downloaded update data in the storage unit 23. After the download is complete, the processing proceeds to step S302.

### Step S302

Next, the compositing unit 92 of the update management ECU 11 creates, from the first update data and the second update data, composite update data for installing composite software including a first function that is a function of the updated first software and a second function that is a function of the updated second software (step S302). Then, the update management ECU 11 proceeds to step S303.

Specifically, for example, the control unit 22 reads out the first update data and the second update data downloaded from the server 2 from the storage unit 23 in which they are temporarily stored. Next, the control unit 22 adds predetermined information to the beginning and end of the data, and joins the first update data and the second update data together to create composite update data for installing the composite software. The predetermined information is, for example, information indicating the beginning of the data, information indicating the end of the data, and information indicating the transmission destination ECU, The composite software installed according to the composite update data has a portion corresponding to the first update data that includes a first function, which is the function of the updated first software, and a portion corresponding to the second update data that includes a second function, which is the function of the updated second software. After creating the composite update data, the update management ECU 11 proceeds to step S303.

### Step S303

Next, the transmission unit 93 of the update management ECU 11 transmits the composite update data to the in-vehicle device including a storage unit, so that the in vehicle device installs the composite software in the storage unit, activates the first function when the power source state of the vehicle is the first power source state, and activates the second function when the power source state of the vehicle is the second power source state (step S303). Then, the update management ECU 11 proceeds to step S304.

Specifically, for example, the control unit 22 transmits the composite update data created by the compositing unit to the communication bus 14b via the transceiver 25b. The transmitted composite update data propagates over the communication bus 14b and reaches the transceiver 35 of the first ECU 12. The control unit 32 receives the composite update data that has reached the transceiver 35. The control unit 32 temporarily stores the received composite update data in the first storage unit 33 or a RAM (not shown).

In the case of FIGS. 5 and 6, the transmission unit 93 transmits, to the door ECU, composite update data for installing composite software including the functions of the door lock software and the window software. Then, the update management ECU 11 proceeds to step S304.

When the first ECU 12 receives the composite update data, the first ECU 12 installs, in the first storage unit 33, the composite software including the functions of the +B software and the IG software according to the received composite update data. In the case of FIGS. 5 and 6, the door ECU installs, in the first storage unit 33, composite software including the functions of the door lock software and the window software.

### Step S304

Next, when the determination unit determines that the power source state of the vehicle is the first power source state, the first instruction unit 95 of the update management ECU 11 transmits, to the in vehicle device, a first activation instruction for activating the first function (step S304). Then, the update management ECU 11 proceeds to step S305.

Specifically, the first instruction unit 95 refers to the ECU tables stored in the storage unit 23, for example, the contents shown in FIGS. 5 and 6. From the referenced ECU tables, the first instruction unit 95 obtains information indicating the power source state in which the software operates to execute the system. In the examples of FIGS. 5 and 6, the function of the door lock software that executes the keyless entry system operates in both the +B state and the IG state, and therefore when the power source state is the +B state, the first instruction unit 95 transmits, to the door ECU, a first activation instruction for activating the function of the door lock software of the updated composite software installed in the first storage unit 33. Then, upon receiving the first activation instruction, the first ECU 12 activates the function of the first software of the composite software.

### Step S305

Next, the determination unit 94 of the update management ECU 11 determines whether the power source state of the vehicle is the first power source state or the second power source state (step S305). If the determination unit 94 determines that the power source state of the vehicle is the second power source state, that is, the IG state, the update management ECU 11 proceeds to step S306. On the other hand, if the determination unit 94 determines that the power source state of the vehicle is the first power source state, that is, the +B state, the update management ECU 11 returns to step S305 and repeats step S305. That is, the update management ECU 11 is waiting for the power source state of the vehicle to transition from the +B state to the IG state.

### Step S306

Next, when the determination unit determines that the power source state of the vehicle is the second power source state, the second instruction unit 96 of the update management ECU 11 transmits, to the in-vehicle device, a second activation instruction for activating the second function (step S306). Then, the update management ECU 11 ends the series of processes.

In the example of FIGS. 5 and 6, the second instruction unit 96 refers to the ECU tables stored in the storage unit 23, the contents of which are shown in FIGS. 5 and 6. From the referenced ECU table, the second instruction unit 96 obtains information indicating the power source state in which the software having a function that executes the system operates. In the example of FIG. 5, the rainy-weather window closing system is executed by the function of the window software and the function of the raindrop detection software operating in the IG state, and therefore when the power source state is the IG state, the second instruction unit 96 transmits, to the door ECU, a second activation instruction for activating the window software function of the updated composite software installed in the first storage unit 33. In addition, the update management device may transmit an activation instruction for activating the function of the raindrop detection software to the sensor ECU as well. Then, upon receiving the second activation instruction, the first ECU 12 activates the function of the second software of the installed composite software.

Note that for the same reason as for the first instruction unit, the second instruction unit may also transmit the second activation instruction to the in-vehicle device after the software has been installed according to the update data.

### Control Sequence

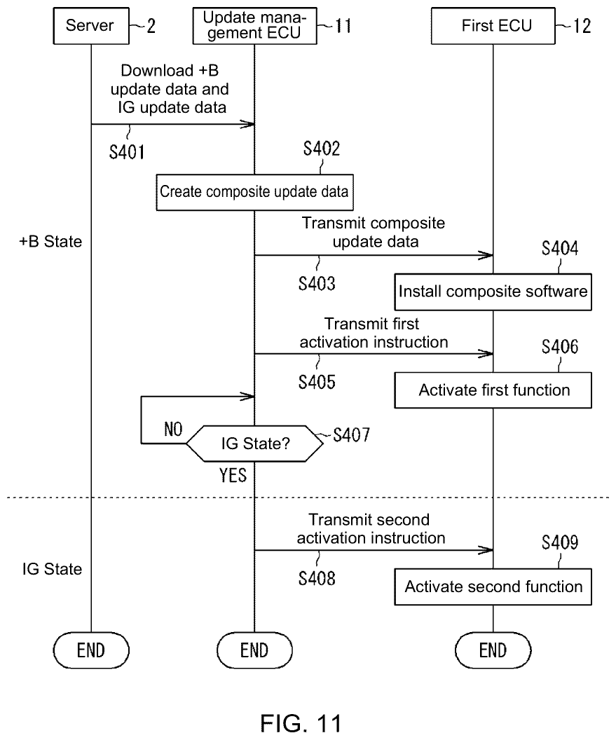

Next, the control sequence of the update management system 1 will be described. FIG. 11 is a sequence diagram of the update management system according to the second embodiment. Note that in the following description, the initial state is assumed to start from a state in which the vehicle cannot travel. Accordingly, in the initial state, the power source state of the vehicle is the +B state. The power source state then transitions from the +B state to the IG state.

### Step S401

First, the reception unit 91 of the update management ECU 11 receives, from an external device outside the vehicle, first update data for updating the first software that operates in the first power source state and the second power source state, and second update data for updating the second software that does not operate in the first power source state but operates in the second power source state (step S401). The update management system 1 then proceeds to step S402.

Specifically, the reception unit 91 downloads the first update data and the second data from the server 2. The server 2 is provided, for example, in a data center of a vehicle manufacturer. The server 2 stores, for example, update data for updating the software of each ECU. The first update data is update data for installing door lock software, which is the +B software of the first ECU 12. The second update data is update data for installing the window software, which is the IG software of the first ECU 12. After the download is complete, the processing proceeds to step S402.

### Step S402

Next, the compositing unit 92 of the update management ECU 11 creates, from the first update data and the second update data, composite update data for installing composite software including a first function that is a function of the updated first software and a second function that is a function of the updated second software (step S402). The update management system 1 then proceeds to step S403.

Specifically, for example, the control unit 22 reads out the first update data and the second update data downloaded from the server 2 from the storage unit 23 in which they are temporarily stored. Next, the control unit 22 adds predetermined information to the beginning and end of the data, and joins the first update data and the second update data together to create composite update data for installing the composite software. The predetermined information is, for example, information indicating the beginning of the data, information indicating the end of the data, and information indicating the transmission destination ECU, The composite software installed by the composite update data has a portion corresponding to the first update data that includes a first function, which is the function of the updated first software, and a portion corresponding to the second update data that includes a second function, which is the function of the updated second software. After creating the composite update data, the update management system 1 proceeds to step 403.

### Step S403

Next, the transmission unit 93 of the update management ECU 11 transmits the composite update data to the in-vehicle device including a storage unit, so that the in vehicle device installs the composite software in the storage unit, activates the first function when the power source state of the vehicle is the first power source state, and activates the second function when the power source state of the vehicle is the second power source state (step S403). Then, the update management system 1 proceeds to step S404.

In the case of FIGS. 5 and 6, the transmission unit 93 transmits, to the door ECU, the composite update data created from the second update data for installing the composite software including the function of the door lock software and the function of the window software. Then, the update management system 1 proceeds to step S404.

### Step S404

Next, when the first ECU 12 receives the composite update data, the first ECU 12 installs the composite software including the functions of the +B software and the IG software according to the received composite update data in the first storage unit 33 (step S404), In the case of FIGS. 5 and 6, the door ECU installs, in the first storage unit 33, composite software including the functions of the door lock software and the window software. After the first ECU 12 installs the software, the update management system 1 proceeds to step S405.

### Step S405

Next, when the determination unit determines that the power source state of the vehicle is the first power source state, the first instruction unit 95 of the update management ECU 11 transmits, to the in vehicle device, a first activation instruction for activating the first function (step S405). Then, the update management system 1 proceeds to step S406.

Specifically, the first instruction unit 95 refers to the ECU tables stored in the storage unit 23, for example, the contents shown in FIGS. 5 and 6. From the referenced ECU tables, the first instruction unit 95 obtains information indicating the power source state in which the software operates to execute the system. In the examples of FIGS. 5 and 6, the function of the door lock software that executes the keyless entry system operates in both the +B state and the IG state, and therefore when the power source state is the +B state, the first instruction unit 95 transmits, to the door ECU, a first activation instruction for activating the function of the door lock software of the updated composite software installed in the first storage unit 33. After transmission, the update management system 1 proceeds to step S406.

### Step S406

Next, upon receiving the first activation instruction, the first ECU 12 activates the function of the first software (step S406). In the examples of FIGS. 5 and 6, the function of the door lock software that executes the keyless entry system is a function of the +B software that operates in both the +B state and the IG state, and therefore the first ECU 12 activates the door lock software function of the updated composite software installed in the first storage unit 33. The update management system 1 then proceeds to step S407,

### Step S407

Next, the determination unit 94 of the update management ECU 11 determines whether the power source state of the vehicle is the first power source state or the second power source state (step S407). If the determination unit 94 determines that the power source state of the vehicle is the second power source state, that is, the IG state, the update management ECU 11 proceeds to step S408. On the other hand, if the determination unit 94 determines that the power source state of the vehicle is the first power source state, that is, the +B state, the update management ECU 11 returns to step S407 and repeats step S408. That is, the update management ECU 11 is waiting for the power source state of the vehicle to transition from the +B state to the IG state.

### Step S408

Next, when the determination unit determines that the power source state of the vehicle is the second power source state, the second instruction unit 96 of the update management ECU 11 transmits a second activation instruction for activating the second function to the in-vehicle device (step S408). Then, the update management system 1 proceeds to step S409.

In the example of FIGS. 5 and 6, the second instruction unit 96 refers to the ECU tables stored in the storage unit 23, the contents of which are shown in FIGS. 5 and 6. From the referenced ECU table, the second instruction unit 96 obtains information indicating the power source state in which the software functions to execute the system. In the example of FIG. 5, the rainy weather window closing system is executed by the function of the window software and the function of the raindrop detection software operating in the IG state, and therefore when the power source state is the IG state, the second instruction unit 96 transmits, to the door ECU, a second activation instruction for activating the window software function of the updated composite software installed in the first storage unit 33. In addition, the update management device may transmit an activation instruction for activating the raindrop detection software to the sensor ECU as well.

### Step S409

Next, upon receiving the second activation instruction, the first ECU 12 activates the function of the updated software (step S409). In the cases of FIGS. 5 and 6, the first ECU 12 activates the function of the window software installed in the first storage unit 33. In addition, if an activation instruction has been transmitted to the second ECU 13, the second ECU 13 activates the function of the installed raindrop detection software. The update management system 1 then ends the series of processes.

### Summary

A vehicle is known which has a plurality of power source states including a +B state, an IG state, and the like, and in which a plurality of ECUs are mounted. In such a vehicle, if the ECU software is updated, there is a risk that multiple pieces of software that cooperate to execute a predetermined system may be activated in different power source states, which can result in one piece of software not being able to understand the command issued by the other piece of software, resulting in the predetermined system not operating.

According to this embodiment, the update management device creates composite update data from a plurality of pieces of update data in advance, and transmits the update data to the in-vehicle device for installing and activating the software in the storage unit of the in vehicle device. The update management device then installs the software in the vehicle-mounted device according to the update data. The update management device then activates the installed software depending on the power source state of the vehicle. As a result, the software of the in-vehicle device is updated and activated sequentially at an appropriate time depending on the power source state, whereby a function that operates due to cooperation between the software of a plurality of ECUs operates without any discrepancies.

Also, if the +B software and the IG software are installed in the first ECU, the IG software is installed in the second ECU, and a predetermined system is executed due to cooperation between the IG software of the first ECU and the IG software of the second ECU, an activation instruction for instructing activation may be transmitted simultaneously to the IG software of the first ECU and the IG software of the second ECU. The IG software of the first ECU and the IG software of the second ECU are explicitly activated simultaneously, which further reduces discrepancies such as the IG software of the first ECU not being able to understand commands issued by the IG software of the second ECU.

### Supplementary Note 1

Note that the present disclosure includes the following control method for an update management device.

A control method for an update management device that manages update of software of an in vehicle device in a vehicle having a plurality of power source states including a first power source state and a second power source state different from the first power source state includes a reception step of receiving, from an external device outside the vehicle, first update data for updating first software that operates in the first power source state and the second power source state, and second update data for updating second software that does not operate in the first power source state but operates in the second power source state; a determination step of determining whether the power source state of the vehicle is the first power source state or the second power source state; a first transmission step of, when it is determined in the determination step that the power source state of the vehicle is the first power source state, transmitting the first update data to the in-vehicle device including a first storage unit and a second storage unit, so that the in vehicle device installs the updated first software in the first storage unit and activates the updated first software; and a second transmission step of, when it is determined in the determination step that the power source state of the vehicle is the second power source state, transmitting the first update data and the second update data to the in-vehicle device so that the in-vehicle device installs the updated first software and the updated second software in the second storage unit and activates the updated first software and the updated second software.

### Supplementary Note 2

Note that the present disclosure includes the following control method for an update management device.

The control method for the update management device according to Supplementary Note 1 further includes: a first activation instruction step of, when it is determined in the determination step that the power source state of the vehicle is the first power source state, transmitting a first activation instruction for activating the updated first software installed in the first storage unit, to the in-vehicle device; and a second activation instruction step of, when it is determined in the determination step that the power source state of the vehicle is the second power source state, transmitting a second activation instruction for activating the updated first software and the update second software installed in the second storage unit, to the in-vehicle device.

### Supplementary Note 3

Note that the present disclosure includes the following control method for an update management system.

A control method for an update management system including an update management device that manages update of software of an in-vehicle device in a vehicle having a plurality of power source states including a first power source state and a second power source state different from the first power source state, and the in-vehicle device, includes: a reception step in which the update management device receives, from an external device outside the vehicle, first update data for updating first software that operates in the first power source state and the second power source state, and second update data for updating second software that does not operate in the first power source state but operates in the second power source state; a determination step of determining whether the power source state of the vehicle is the first power source state or the second power source state; a first transmission step of, when it is determined in the determination step that the power source state of the vehicle is the first power source state, transmitting the first update data to the in vehicle device including a first storage unit and a second storage unit, so that the in vehicle device installs the updated first software in the first storage unit and activates the updated first software; a second transmission step of, when it is determined in the determination step that the power source state of the vehicle is the second power source state, transmitting the first update data and the second update data to the in-vehicle device so that the in-vehicle device installs the updated first software and the updated second software in the second storage unit and activates the updated first software and the updated second software; a first activation instruction step of, when it is determined in the determination step that the power source state of the vehicle is the first power source state, transmitting a first activation instruction for activating the updated first software installed in the first storage unit, to the in-vehicle device; a second activation instruction step of, when it is determined in the determination step that the power source state of the vehicle is the second power source state, transmitting a second activation instruction for activating the updated first software and the updated second software installed in the second storage unit, to the in-vehicle device; a first activation step in which the in-vehicle device activates the updated first software installed in the first storage unit, when the first activation instruction is received; and a second activation step in which the in-vehicle device activates the updated first software and the updated second software installed in the second storage unit, when the second activation instruction is received.

### Supplementary Note 4

Note that the present disclosure includes the following control method for an update management system.

A control method for an update management system including an update management device that manages update of software of an in-vehicle device in a vehicle having a plurality of power source states including a first power source state and a second power source state different from the first power source state, and the in-vehicle device, includes: a reception step in which the update management device receives, from an external device outside the vehicle, first update data for updating first software that operates in the first power source state and the second power source state, and second update data for updating second software that does not operate in the first power source state but operates in the second power source state; a determination step in which the update management device determines whether the power source state of the vehicle is the first power source state or the second power source state; a first transmission step in which, when it is determined in the determination step that the power source state of the vehicle is the first power source state, the update management device transmits the first update data to the in-vehicle device including a first storage unit and a second storage unit, so that the in-vehicle device installs the updated first software in the first storage unit; a second transmission step in which, when it is determined in the determination step that the power source state of the vehicle is the second power source state, the update management device transmits the first update data and the second update data to the in-vehicle device, so that the in-vehicle device installs the updated first software and the updated second software in the second storage unit; a first activation step in which the in-vehicle device activates the updated first software installed in the first storage unit according to the first update data transmitted in the first transmission step; and a second activation step in which the in vehicle device activates the updated first software and the updated second software installed in the second storage unit according to the first update data and the second update data transmitted in the second transmission step.

### Supplementary Note 5

Note that the present disclosure includes the following control method for an update management device.

A control method for an update management device that manages update of software of an in vehicle device in a vehicle having a plurality of power source states including a first power source state and a second power source state different from the first power source state, includes: a reception step of receiving, from an external device outside the vehicle, first update data for updating first software that operates in the first power source state and the second power source state, and second update data for updating second software that does not operate in the first power source state but operates in the second power source state; a compositing step of creating, from the first update data and the second update data, composite update data for installing composite software including a first function that is a function of the updated first software and a second function that is a function of the updated second software; and a transmission step of transmitting the composite update data to the in-vehicle device including a storage unit, so that the in-vehicle device installs the composite software in the storage unit, activates the first function when the power source state of the vehicle is the first power source state, and activates the second function when the power source state of the vehicle is the second power source state.

### Supplementary Note 6

Note that the present disclosure includes the following control method for an update management device.

The control method for the update management device according to Supplementary Note 4 further includes: a determination step of determining whether the power source state of the vehicle is the first power source state or the second power source state; a first activation instruction step of, when it is determined in the determination step that the power source state of the vehicle is the first power source state, transmitting a first activation instruction for activating the first function to the in-vehicle device; and a second activation instruction step of, when it is determined in the determination step that the power source state of the vehicle is the second power source state, transmitting a second activation instruction for activating the second function to the in-vehicle device.

### Supplementary Note 7

Note that the present disclosure includes the following control method for an update management system.

A control method for an update management system including an update management device that manages update of software of an in-vehicle device in a vehicle having a plurality of power source states including a first power source state and a second power source state different from the first power source state, the control method comprising: a reception step in which the update management device receives, from an external device outside the vehicle, first update data for updating first software that operates in the first power source state and the second power source state, and second update data for updating second software that does not operate in the first power source state but operates in the second power source state; a compositing step of creating, from the first update data and the second update data, composite update data for installing composite software including a first function that is a function of the updated first software and a second function that is a function of the updated second software; and a transmission step of transmitting the composite update data to the in vehicle device including a storage unit, so that the in vehicle device installs the composite software in the storage unit, activates the first function when the power source state of the vehicle is the first power source state, and activates the second function when the power source state of the vehicle is the second power source state; a determination step of determining whether the power source state of the vehicle is the first power source state or the second power source state; a first activation instruction step of, when it is determined in the determination step that the power source state of the vehicle is the first power source state, transmitting a first activation instruction for activating the first function, to the in-vehicle device; a second activation instruction step of, when it is determined in the determination step that the power source state of the vehicle is the second power source state, transmitting a second activation instruction for activating the second function, to the in-vehicle device; a first activation step in which the in-vehicle device activates the first function when the first activation instruction is received; and a second activation step in which the in vehicle device activates the second function when the second activation instruction is received.

### Supplementary Note 8

Note that the present disclosure includes the following control method for an update management system.

A control method for an update management system including an update management device that manages update of software of an in-vehicle device in a vehicle having a plurality of power source states including a first power source state and a second power source state different from the first power source state, and the in-vehicle device, includes: a reception step in which the update management device receives, from an external device outside the vehicle, first update data for updating first software that operates in the first power source state and the second power source state, and second update data for updating second software that does not operate in the first power source state but operates in the second power source state; a compositing step of creating, from the first update data and the second update data, composite update data for installing composite software including a first function, which is a function of the updated first software, and a second function, which is a function of the updated second software; a transmission step of transmitting the composite update data to the in-vehicle device including a storage unit, so that the in-vehicle device installs the composite software in the storage unit; a first activation step in which the in-vehicle device activates the first function of the composite software installed in the storage unit when the power source state of the vehicle is the first power source state; and a second activation step in which the in vehicle device activates the second function of the composite software installed in the storage unit when the power source state of the vehicle is the second power source state.

### Supplementary Note 9

Note that at least some of the above-described embodiments and various modified examples may be combined with each other as appropriate. In addition, the embodiments and modifications disclosed herein are to be considered as illustrative in all respects and not restrictive. The scope of the present disclosure is indicated by the claims, and all modifications within the meaning and scope equivalent to the claims are intended to be encompassed therein.

1. An update management device for managing update of software of an in-vehicle device in a vehicle having a plurality of power source states including a first power source state and a second power source state different from the first power source state, the update management device comprising:
a reception unit configured to receive, from an external device outside the vehicle, first update data for updating first software that operates in the first power source state and the second power source state, and second update data for updating second software that does not operate in the first power source state but operates in the second power source state;
a compositing unit configured to create, from the first update data and the second update data, composite update data for installing composite software including a first function that is a function of the updated first software and a second function that is a function of the updated second software; and
a transmission unit configured to transmit the composite update data to the in-vehicle device including a storage unit, so that the in-vehicle device installs the composite software in the storage unit, activates the first function when the power source state of the vehicle is the first power source state, and activates the second function when the power source state of the vehicle is the second power source state.

2. The update management device according to claim 1, further including;
a determination unit configured to determine whether the power source state of the vehicle is the first power source state or the second power source state;
a first instruction unit configured to, when the determination unit determines that the power source state of the vehicle is the first power source state, transmit a first activation instruction for activating the first function to the in-vehicle device; and
a second instruction unit configured to, when the determination unit determines that the power source state of the vehicle is the second power source state, transmit a second activation instruction for activating the second function to the in-vehicle device.

3. The update management device according to claim 2,
wherein when it is determined that the power source state of the vehicle is the first power source state, the determination unit stores information indicating that the power source state is the first power source state in a state storage unit configured to store information indicating the power source state,
when it is determined that the power source state of the vehicle is the second power source state, the determination unit stores information indicating that the power source state is the second power source state in the state storage unit,
the first instruction unit refers to the state storage unit, and transmits the first activation instruction to the in-vehicle device when information indicating the first power source state has been stored, and
the second instruction unit refers to the state storage unit, and transmits the second activation instruction to the in-vehicle device when information indicating the second power source state has been stored.

4. The update management device according to claim 1, wherein the first power source state is a power source state at a time when the vehicle is in a state of not being able to travel, and the second power source state is a power source state at a time when the vehicle is in a state of being able to travel.

5. The update management device according to claim 1, wherein the reception unit receives the first update data and the second update data from the external device while the power source state is the first power source state.

6. An update management system comprising:
the update management device according to claim 1; and
the in-vehicle device.

7. An update management system comprising:
an update management device configured to manage update of software of an in-vehicle device in a vehicle having a plurality of power source states including a first power source state and a second power source state different from the first power source state; and the in-vehicle device,
wherein the update management device includes:
a reception unit configured to receive, from an external device outside the vehicle, first update data for updating first software that operates in the first power source state and the second power source state and second update data for updating second software that does not operate in the first power source state but operates in the second power source state;
a compositing unit configured to create, from the first update data and the second update data, composite update data for installing composite software including a first function that is a function of the updated first software and a second function that is a function of the updated second software;
a transmission unit configured to transmit the composite update data to the in-vehicle device including a storage unit, so that the in-vehicle device installs the composite software in the storage unit, activates the first function when the power source state of the vehicle is the first power source state, and activates the second function when the power source state of the vehicle is the second power source state;
a determination unit configured to determine whether the power source state of the vehicle is the first power source state or the second power source state;
a first instruction unit configured to, when the determination unit determines that the power source state of the vehicle is the first power source state, transmit a first activation instruction for activating the first function to the in-vehicle device; and
a second instruction unit configured to, when the determination unit determines that the power source state of the vehicle is the second power source state, transmit a second activation instruction for activating the second function to the in-vehicle device, and
the in-vehicle device includes:
a first activation unit configured to activate the first function when the first activation instruction is received; and
a second activation unit configured to activate the second function when the second activation instruction is received.

8. The update management system according to claim 7,
wherein when it is determined that the power source state of the vehicle is the first power source state, the determination unit stores information indicating that the power source state is the first power source state in a state storage unit configured to store information indicating the power source state,
when it is determined that the power source state of the vehicle is the second power source state, the determination unit stores information indicating that the power source state is the second power source state in the state storage unit,
the first instruction unit refers to the state storage unit, and transmits the first activation instruction to the in-vehicle device when information indicating the first power source state has been stored, and
the second instruction unit refers to the state storage unit, and transmits the second activation instruction to the in-vehicle device when information indicating the second power source state has been stored.

9. (canceled)
